(19) United States
(12) Patent Application Publication
(10) Pub. No.: US 2004/0160336 A1
(43) Pub. Date: Aug. 19, 2004

(54) Interactive system

(76) Inventors: David Hoch, Watertown, MA (US); Andrew Kennedy Lang, Wellesley, MA (US)

Correspondence Address: Richman and Associates, PO Box 3333, La Jolla, CA, 92038-3333, US

(21) Appl. No.: 10/779,089

(22) Filed: Feb. 13, 2004

Related U.S. Application Data
(63) Continuation-in-part of application No. 10/285,342, filed on Oct. 30, 2002.
(60) Provisional application No. 60/447,844, filed on Feb. 14, 2003.

(51) Int. Cl. F21V 33/00; G05B 19/02; G06K 9/00; F21V 1/00

(52) U.S. Cl. 340/825.22; 362/85; 382/103; 362/276

(57) ABSTRACT

A system and method are provided for interacting one or more individuals. The apparatus and method allow a playing surface to interact with a user or a physical object. The physical object is associated with goods suitable for use with the system, such as balls, foot ware, racquets and other suitable goods. The system is capable of tracking each user and tracking each physical object. The system is illuminable in a spectrum of colors under control of a computer. The computer can control the illumination of the system based in part on detected movement or predicted movement or both, of a user and of a physical object. Moreover, the system provides a number of pressure sensitive surfaces to detect and track a user. The system is suitable for placement on a floor, a ceiling, and one or more walls or any combination thereof.

### CROSS REFERENCE TO RELATED APPLICATIONS

This invention is a continuation in part of Utility patent application Ser. No. 10/285342, filed Oct. 30, 2002, Attorney Docket Number LSQ-001, and entitled “Interactive Modular System” and is related to Provisional Patent Application 60/447844, filed Feb. 14, 2003, Attorney Docket Number LSQ-003, and entitled “Interactive System”, which is hereby incorporated by reference for its teachings.

### BACKGROUND

1. Field of the Invention

The present invention generally relates to a lighting system, and more particularly, to an interactive system that interacts with the users.

2. Description of Related Art

There are a number of different illuminable entertainment and amusement systems in use today that utilize sensory stimuli, such as sound and lights, to entertain and interact with a user. An example of such a system is a lighted dance floor or a video game system found in an entertainment complex. Unfortunately, these amusement and entertainment systems found in an entertainment complex are of a fixed dimensional size. Consequently, the installation and removal of these amusement systems are burdensome and costly.

In addition, the conventional amusement or entertainment system is limited in its ability to interact with the user. For example, a typical lighted dance floor provides little, if any interaction with the user. The dance floor provides a preset visual output controlled by a disc jockey or lighting effects individual or coordinated to a sound output. Moreover, video game systems currently available from various manufacturers, such as Microsoft®, Sega®, Sony® and the like are also limited in their ability to interact with the user. For example, the number of users is limited; each user must use a hand-held controller to interact with the video game system.

Although entertainment and amusement systems in entertainment complexes are more interactive than illuminated dance floors, they rely upon pressure sensors in a floor portion to sense and track the user. As such, conventional entertainment and amusement systems are reactive to the user and are unable to detect in which direction a user is heading as they step onto another segment of the floor portion and how quickly the user is heading in that particular direction. Moreover, the entertainment and amusement systems typically found in entertainment complexes are of a limited size that places a significant limit on the number of users that can interact with the system. As a consequence, conventional entertainment and amusement systems lack the ability to determine a possible future location of a user, a portion of a user, or a physical object as they are moved or positioned on or above the floor.

### SUMMARY OF THE INVENTION

The present invention addresses the above-described limitations by providing a system that is adaptable to a physical location and provides an approach for the system to sense and track a user, or physical object, even if the user is not standing on a floor element of the system. The present invention provides an interactive system that includes the ability to sense and predict a direction in which a user is moving without the need for pressure like sensors in an illuminable element of the system.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 depicts a block diagram of a system suitable for practicing the illustrative embodiment of the present invention.

FIG. 2 illustrates an exemplary configuration of a system suitable for producing an illustrative embodiment of the present invention.

FIG. 3 depicts a flow diagram illustrating steps taken for practicing an illustrative embodiment of the present invention.

FIG. 4 illustrates a block diagram of an illuminable assembly suitable for practicing the illustrative embodiment of the present invention.

FIG. 5 illustrates a block diagram of an illuminable assembly suitable for practicing the illustrative embodiment of the present invention.

FIG. 6 is a block diagram suitable for use with the illuminable assembly illustrated in FIG. 4 or 5.

FIG. 7 is a block diagram of a pixel suitable for use with the illuminable assembly illustrated in FIG. 4 or 5.

FIG. 8 is a block diagram of a receiver suitable for us with the illuminable assembly illustrated in FIG. 4 or 5.

FIG. 9 is a block diagram of a speaker suitable for use with the illuminable assembly illustrated in FIG. 4 or 5.

FIG. 10 is a block diagram of a pressure sensory suitable for use with the illuminable assembly illustrated in FIG. 4 or 5.

FIG. 11 is a block diagram of a physical object suitable for practicing an illustrative embodiment of the present invention.

FIG. 12 is a flow diagram illustrating steps taken for communication with a physical object suitable for practicing an illustrative embodiment of the present invention.

FIG. 13 is a block diagram of a controller suitable for use with the physical object illustrated in FIG. 11.

FIG. 14 is a block diagram of a first interface circuit suitable for use with the controller illustrated in FIG. 11.

FIG. 15 is a block diagram of a second interface circuit suitable for use with the controller illustrated in FIG. 11.

FIG. 16 is an exploded view of the illuminable assembly illustrated in FIG. 4.

FIG. 17 is a bottom view of the top portion of the illuminable assembly illustrated in FIG. 16.

FIG. 18 is a side view of pixel housing suitable for use with the illuminable assembly depicted in FIG. 16.

FIG. 19 is a prospective view of a reflective element suitable for use with pixel housing of the illuminable assembly depicted in FIG. 16.

FIG. 20 is a bottom view of a mid-portion of the illuminable assembly depicted in FIG. 16.

FIG. 21 A is a block diagram of transmitters on a physical object.

FIG. 21 B is a block diagram of the patterns formed by the receivers on the illuminable assembly that are receiving signals from the transmitters depicted in FIG. 21A horizontally oriented to the illuminable assembly.

FIG. 22 is a flowchart of the sequence of steps followed by the illustrative embodiment of the present invention to determine the position and orientation of the physical object relative to the illuminable assembly.

### DETAILED DESCRIPTION

Throughout this description, embodiments and variations are described for the purpose of illustrating uses and implementations of the invention. The illustrative description should be understood as presenting examples of the invention, rather than as limiting the scope of the invention.

The illustrative embodiment of the present invention provides an interactive system, which can be modular, which interacts with a user by communicating with the user through illumination effects, sound effects, and other physical effects. The system based on the communications with the user generates one or more outputs for additional interaction with the user. Specifically, the system detects and tracks each user or physical object as a distinct entity to allow the system to interact with and entertain each user individually. As such, the system utilizes a number of variables, such as the user profile for a specific user, a current location of each user, a possible future location of each user, the type of entertainment event or game in progress and the like, to generate one or more effects to interact with one or more of the users. The effects generated by the system typically affect one or more human senses to interact with each of the users.

In the illustrative embodiment, the system includes an illuminable floor or base portion capable of sensing applied surface pressure, or sensory activities and movements of users and other physical objects, or both, to form an entertainment surface. Each physical object communicates with at least a portion of the illuminable base portion. The physical object and the illuminable base portion are capable of providing an output that heightens at least one of the user's physical senses.

According to one embodiment, the present invention is attractive for use in a health club environment for providing aerobic exercise. The system of the present invention is adapted to operate with a plurality of physical objects. Some of the physical objects are associated with individual users to provide a resource for user preferences, billing information, membership information, and other types of information. The physical objects operate independently of each other and allow the system to determine a current location of each physical object and a possible future location of each physical object, and, hence, a user or individual if associated therewith. As such, the system is able to interact with each user on an individual basis. To interact with each user, the system typically provides feedback to each user by generating an output signal capable of stimulating or heightening one of the user senses.

Typical output signals include an audio output, a visual output, a vibrational output or any other suitable output signal capable of heightening one of the user senses. As such, the system is able to entertain, amuse, educate, train, condition, challenge, one or more users by restricting or otherwise directing the movement of users through the generation of the various output signals. Moreover, the system of the present invention is suitable for use in a number of venues, for example, a stage floor or use as stage lighting, a dance floor, a wall or ceiling display, health club activities such as one or more sports involving a ball and racquet, for example, tennis, squash or a sport, such as basketball or handball not requiring a racquet, classrooms, halls, auditoriums, convention centers and other like venues.

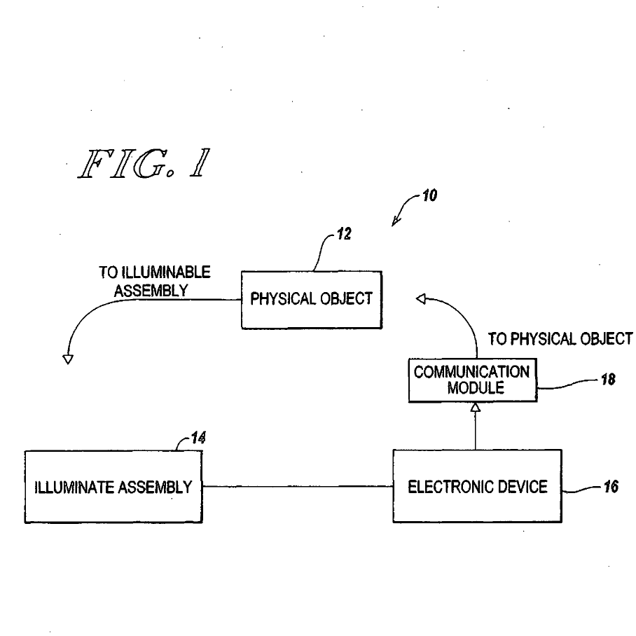

FIG. 1 is a block diagram of a system 10 that is suitable for practicing the illustrative embodiment of the present invention. According to an illustrative embodiment, a physical object 12 communicates with a portion of an illuminable assembly 14 to allow the system 10 to determine a present location of the physical object 12 relative to the illuminable assembly 14. The illuminable assembly 14 is also in communication with the electronic device 16 to provide the electronic device 16 with the data received from the physical object 12 and with data generated, collected or produced by the illuminable assembly 14. The data received from the physical object 12, and the illuminable assembly 14, either alone or in combination, allows the electronic device 16 to identify and determine the location of the physical object 12, and to control the operation of the illuminable assembly 14.

The electronic device 16 includes one or more processors (not shown) to process the data received from the physical object 12 and the illuminable assembly 14, and to control operation of the system 10. Electronic devices suitable for use with the system 10 include, but are not limited to, personal computers, workstations, personal digital assistants (PDA's) or any other electronic device capable of responding to one or more instructions in a defined manner. Those skilled in the art will recognize that the system 10 can include more than one illuminable assembly 14, more than one physical object 12, more than one electronic device 16, and more than one communication module 18, which is discussed below in more detail.

The communication link between the illuminable assembly 14 and the electronic device 16 is typically configured as a bus topology and may conform to applicable Ethernet standards, for example, 10 Base-2, 10 Base-T or 100 Base-T standards. Those skilled in the art will appreciate that the communication link between the illuminable assembly 14 and the electronic device 16 can also be configured as a star topology, a ring topology, a tree topology or a mesh topology. In addition, those skilled in the art will recognize that the communication link can also be adapted to conform to other Local Area Network (LAN) standards and protocols, such as a token bus network, a token ring network, an apple token network or any other suitable network including customized networks. Nevertheless, those skilled in the art will recognize that the communication link between the illuminable assembly 14 and the electronic device 16 can be a wireless link suitable for use in a wireless network, such as a Wi-Fi compatible network or a Bluetooth® compatible network or other like wireless networks.

The electronic device 16 communicates with the physical object 12 via communication module 18 in a wireless manner to enable the physical object 12 to generate an output that is capable of providing feedback to a user associated with the physical object 12. The communication module 18 communicates with the electronic device 16 using a wired communication link, for example) a co-axial cable, fiber optic cable, twisted pair wire or other suitable wired communication link. Nevertheless, the communications module 18 can communicate with the electronic device 16 in a wireless manner using a wireless communication link, for example, a Bluetooth™ link, a Wi-Fi link, or other suitable wireless link. The communication module 18 provides the means necessary to transmit data from the electronic device 16 to the physical object 12 in a wireless manner. Nonetheless, the physical object 12 is capable of communicating with the electronic device 16 or with the illuminable assembly 14 or with both in a wired manner using an energy conductor, such as one or more optical fibers) coaxial cable, tri-axial cable, twisted pairs, flex-print cable, single wire or other like energy conductor.

In operation, the communication module 18 communicates with the physical object 12 using a radio frequency (RF) signal carrying one or more data packets from the electronic device 16. The RF data packets each have a unique identification value that identifies the physical object 12 that the packet is intended for. The physical object 12 listens for a data packet having its unique identification value and receives each such packet. Those skilled in the art will recognize that other wireless formats, such as code division multiple access (CDMA), tine division multiplexing access (TDMA), Bluetooth technology and wireless fidelity in accordance with IEEE 802.11 b are also suitable wireless formats for use with the system 10. Moreover, those skilled in the art will recognize that the communication module 18 can be incorporated into the electronic device 16, for example as a wireless modem or as a Bluetooth capable device. Furthermore, those skilled in the art will recognize that the various wireless communications utilized by the system 10 can be in one or more frequency ranges, such as the radio frequency range, the infrared range, and the ultra sonic range or that the wireless communications utilized by the system 10 include magnetic fields.

Optionally, the illuminable assembly 14 is configurable to transmit data in a wireless manner to each of the physical objects 12. In this manner, the illuminable assembly 14 is able to transmit data, such as instructions, control signals or other like data to each of the physical objects 12. As such the illuminable assembly 14 is able to transmit data to the physical object 12 without having to first pass the data to the electronic device 16 for transmission to the physical object 12 via the communication module 18.

Typically, each user is assigned a physical object 12. In addition, the physical object 12 is suitable for integration into one or more goods for use with the system 10. Suitable goods include, but are not limited to footwear, clothing, balls, bats, gloves, wands, racquets, pointing devices, weapons, and other similar goods for use in entertainment, amusement, exercise and sports. In this manner, the integration of the physical object 12 into selected goods allows the system 10 to add an additional level of interaction with the user to increase the user's overall entertainment experience.

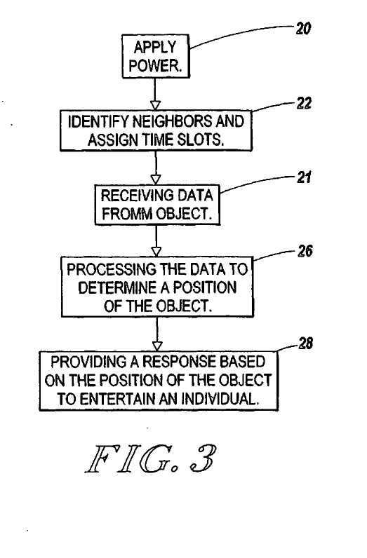

In operation, thee illuminable assembly 14, the electronic device 16 and the physical object 12 communicate with each other using data packets and data frames. Data packets are transferred between the illuminable assembly 14 and the electronic device 16 using data frames that conform to the applicable Ethernet standard or other suitable protocol, such as RS-485, RS-422, or RS-232. Likewise, data frames are transferred using data frames between the physical object 12 and the illuminable assembly 14 using infrared communications which can be compatible with standards established by the Infrared Data Association IrDA) or compatible with one or more other infrared communication protocols. The operation of the system 10 is discussed below in more detail with reference to FIG. 3.

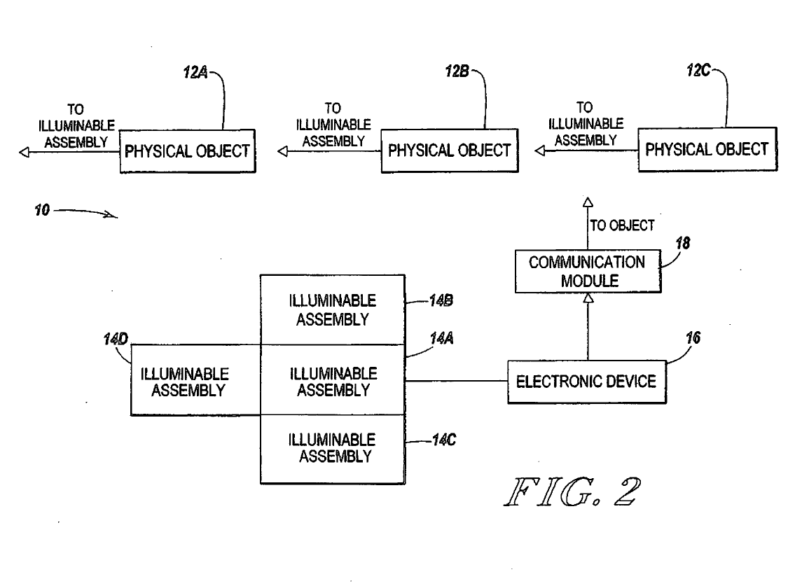

FIG. 2 illustrates an exemplary configuration of the system 10. As FIG. 2 illustrates, the system 10 is configurable so that a plurality of illuminable assemblies 14A through 14D are coupled in a manner to form a continuous or near-continuous platform, a floor or a portion of a floor, or coupled in a manner to cover all or a portion of a ceiling, or one or more walls or both. For example, illuminable assembly 14A abuts illuminable assembly 14B, illuminable assembly 14C and illuminable assembly 14D. Each illuminable assembly 14A through 14D includes a number of connectors (not shown) on each side portion or a single side portion of the illuminable assembly that allow for each illuminable assembly to communicate control signals, data signals and power signals to each abutting illuminable assembly 14.

In addition, the interactive system 10 is able to entertain a plurality of users; the number of users is typically limited only by the size and number of illuminable assemblies 14 that are coupled together. Those skilled in the art will also recognize that the system 10 can place a number of illuminable assemblies 14 on a wall portion of the room and a ceiling portion of the room in addition to covering the floor portion of a room with the illuminable assembly 14. Nevertheless, those skilled in the art will further recognize that the system 10 can have in place on a floor portion of a room a number of the illuminable assemblies 14 and have in place in the room one or more other display devices that can render an image provided by the system 10. Suitable other display devices include, but are not limited to cathode ray tube (CRT) devices, kiosks, televisions, and projectors with screens, plasma displays, crystal displays, and other suitable display devices.

In this manner, the other display devices can form one or more walls or portions of one or walls to render one or more images in conjunction with the illuminable assembly 14 on the floor portion of the room. Moreover, the additional or other display devices are capable of communicating directly with the electronic device 16, or indirectly with the electronic device 16, for example. Through the illuminable assembly 14 or the physical object 12. As such, the other display devices are capable of providing additional information or visual entertainment to users of the system 10. In addition, each illuminable assembly 14 includes a unique serial number or identifier. In this manner, the unique identifier allows the electronic device 16 and optionally the physical object 12, to select or identify which of the one or more illuminable assemblies 14A-14D it is communicating with. Those skilled in the art will recognize that the system 10 can be configured so that a plurality of illuminable assemblies form various shapes or patterns on a floor, wall, ceiling or a combination thereof.

Moreover, the system 10 can be configured into one or more groups of illuminable assemblies, so that a first group of illuminable assemblies due not abut a second group of illuminable assemblies. Furthermore, those skilled in the art will recognize that an illuminable assembly 14 can be formed in a number of sizes. For example, a single illuminable assembly can be formed to fill the floor space of an entire room, or alternatively, multiple illuminable assemblies can be formed and coupled together to fill the same floor space.

The system 10 is further configurable to include one or more sound systems in communication with the electronic device 16 to provide additional information or audio entertainment to the user of the system 10. Components of the one or more sound systems include an amplifier for amplifying an audio signal from the electronic device 16 and for driving one or more pairs of speakers with the amplified audio signal. The amplifier can be incorporated into each speaker so that the amplifier is contained within close proximity to each speaker or speaker enclosure, or alternatively, there can be one or more amplifiers that are distinct units separate from each speaker or speaker enclosure that are capable of driving multiple pairs of speakers either directly or indirectly through one or more switches. Moreover, the electronic device 16 is capable of communicating with each amplifier or with each speaker using a wireless transmission medium or a wired transmission medium.

Furthermore, each user of the system 10 is capable of being outfitted and equipped with headphones that communicate with the electronic device 16. Nevertheless, the headphones can be bidirectional capable of transmitting requests from the user to the system 10 and, in turn, receiving responses from the system 10. In this manner, the electronic device 16 is capable of sending, either in a wireless manner or a wired manner, information to a selected headphone set associated with a particular user.

This allows the system 10 to provide the selected user with audible clues, instructions, sounds or other like audible communications. The one or more sounds systems coupled to the electronic device 16 can include other sound system components such as, graphic equalizers and other like sound system components.

The system 10 further includes one or more image capturing devices that communicate captured image information to the electronic device 16. Suitable image capturing devices include cameras capable of producing a digitized image either in a still format or a video format. Other suitable image capturing devices include cameras that do not produce a digitized image, but are capable of sending an image to another device to digitize that image and forward the digitized image to the electronic device 16. In this manner, the turn, capturing devices can provide a live video feed to the electronic device 16 which, in turn, can display the video images on the illuminable assembly 14 or on the other display devices associated with the system 10.

The electronic device 16 is capable of communicating with each image capturing device to provide commands and controls that direct each image capturing device to pan, tilt, zoom, enhance or distort a portion of the image, or provide other image effects. The image capturing devices can be arranged to capture images of the system 10 from various angles or to acquire specific portions of the system 10 as desired by the users, the operator of the system, or the owner of the system.

Moreover, the image capturing devices are capable of communicating with the electronic device 16 in a wireless manner to allow users of the system 10 to attach or wear one of the image capturing devices.

Furthermore, the system 10 is capable of including one or more microphones that communicate with the electronic device 16 to provide audio information such as voice commands from users or to provide the electronic device 16 with other environmental sounds. As such, the electronic device 16 is capable of performing voice and speech recognition tasks and functions, for example, raising or lowering the volume of the sound system or providing commands to the image capturing devices based on the utterances of the users.

FIG. 3 illustrates steps taken to practice an illustrative embodiment of the present invention. Upon physically coupling the illuminable assembly 14 to the electronic device 16, and applying power to the illuminable assembly 14, the electronic device 16, the physical object 12 and if necessary the communications module 18, the system 10 begins initialization. During initialization, the electronic device 16, the illuminable assembly 14 and the physical object 12 each perform one or more self-diagnostic routines. After a time period selected to allow the entire system 10 to power up and perform one or more self-diagnostic routines, the electronic device 16 establishes communications with the illuminable assembly 14 and the physical object 12 to determine an operational status of each item and to establish each item's identification (step 20).

Once the electronic device 16 identifies each illuminable assembly 14 and physical object 12 in the system 10, the electronic device 16 polls a selected illuminable assembly 14 to identify all abutting illuminable assemblies for example, illuminable assembly 14B-14D (step 22). The electronic device 16 polls each identified illuminable assembly 14 in this manner to allow the electronic device 16 to generate a map that identifies a location for each illuminable assembly 14 in the system 10. Nevertheless, those skilled in the art will recognize that it is possible to have a sole illuminable assembly 14 and hence, not have an abutting illuminable assembly. In addition to mapping each illuminable assembly 14 as part of the initialization of the system 10, the electronic device 16 receives from each physical object 12 the object's unique identification value and in turn, assigns each physical object 12 a time slot for communicating with each illuminable assembly }4 in the system 10 (step 22). Upon mapping of each illuminable assembly 14 and assignment of time slots to each physical object 12, the system 10 is capable of entertaining or amusing one or more users.

In operation, the illuminable assembly 14 receives a data frame from the physical object 12. The data frame contains indicia to identify the physical object 12 and data regarding an acceleration value of the physical object 12 (step 24). A suitable size of a data frame from the physical object 12 is about 56 bits; a suitable frame rate for the physical object 12 is about twenty frames per second. In one embodiment, each user is assigned two physical objects 12. The user attaches a first physical object 12 to the tongue or lace portion of a first article of footwear and attaches a second physical object 12 to the tongue or lace portion of a second article of footwear. The physical object 12 is discussed below in more detail with reference to FIG. 10. Moreover, those skilled in the art will recognize that the physical object 12 is attachable or embeddable in multiple physical objects such as, clothing, bats, balls, gloves, wands, weapons, pointing devices, and other physical objects used in gaming, sporting and entertainment activities.

When the illuminable assembly 14 receives a data frame from the physical object 12, the illuminable assembly 14 processes the data frame to identify the source of the data frame and if instructed to, validate the data in the frame by confirming a Cyclic Redundancy Check (CRC) value or checksum value or other method of error detection provided in the frame (step 24). Once the illuminable assembly 14 processes the data frame from the physical object 12, the illuminable assembly 14 generates an Ethernet compatible data packet that contains the data from the physical object 12 and transfers the newly formed Ethernet packet to the electronic device 16 which, in turn, determines a present location of the physical object 12 in the system 10. The electronic device 16 determines the present location of the physical object 12 based on the data transmitted by the physical object 12 along with the source address of the illuminable assembly 14 that transfers the data from the physical object 12 system 10. In this manner, if the physical object 12 is attached to or held by a particular user, that user's location in the interactive system 10 is known. Similarly, the physical object 12 is a ball, stick, puck, or other physical object, the system 10 is able to determine a physical location of that object in the system. Those skilled in the art will recognize that the illuminable assembly 14 is capable of transmitting data using an IR signal to the physical object 12.

The electronic device 16 processes the acceleration data or the position data provided by the physical object 12 to determine a position of the physical object 12 and optionally a speed of the physical object 12 or a distance of the physical object 12 relative to the physical object's last reported location or a fixed location in the system 10, or both a speed and distance of the physical object 12 (step 26). The electronic device 16 directs the illuminable assembly 14 to generate an output based on a position of the physical object 12 and optionally an output based on the velocity of the physical object 12 and optionally the distance traveled by the physical object 12. The output is capable of stimulating one of the user's senses to entertain and interact with the user (step 28). In addition, the electronic device 16 can direct the physical object 12 to generate on output capable of stimulating one of the user's senses to entertain and interact with the user for example, to rotate, illuminate or both. Moreover, those skilled in the art will recognize that the physical object 12 is capable of communicating with the electronic device 16 and the illuminable assembly 14 to provide information relating to location, identification, acceleration, velocity, angle distance, and other physical or logical parameters concerning the physical object.

The illuminable assembly 14 is capable of generating a visual output in one or more colors to stimulate the users' visual senses. Depending on the mode of the system 10, the visual output generated by the illuminable assembly 14 can provide feedback to the user in terms of instructions or clues. For example, the illuminable assembly 14 can illuminate in a green color to indicate to the user that they should move in that direction or to step onto the illuminable assembly 14 illuminated green or to hit or throw the physical object 12 so that it contacts the illuminable assembly 14 illuminated green. In similar fashion, the illuminable assembly 14 can be instructed to illuminate in a red color to instruct the user not to move in a particular direction or not to step onto the illuminable assembly 14 illuminated red. Nevertheless, those skilled in the art will recognize that the illuminable assembly 14 is controllable to illuminate or display a broad spectrum of colors. Other examples of visual affects that the system 10 is capable of generating include, but are not limited to generation of mazes for the user to walk through, explosions similar to a star burst or fireworks display, roads, roadways, rooms, surface terrain's and other affects to guide, entertain, restrict, teach or train the user.

The physical object 12 can also provide the user with feedback or instructions to interact with the system 10. For example, the electronic device 16 or the illuminable assembly 14 can instruct a selected physical object 12 associated with a selected user can generate a visual output in a particular color to illuminate the selected physical object 12. In this manner the interactive system 10 provides an additional degree of interaction with the user. For example, the visual output of the physical object 10 can indicate that the selected user is no longer an active participant in a game or event, or that the selected user should be avoided, such as the person labeled “it” in a game of tag. The electronic device 16 and the illuminable assembly 14 can also instruct the selected physical object 12 to generate a vibrational output.

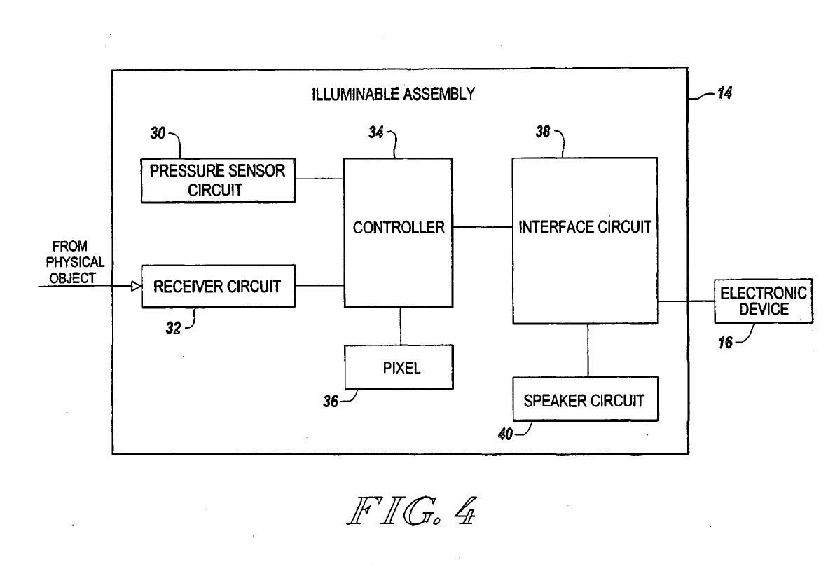

FIG. 4 schematically illustrates the illuminable assembly 14 in more detail. A suitable mechanical layout for the illuminable assembly 14 is described below in more detail relative to FIG. 15. The illuminable assembly 14 is adapted to include an interface circuit 38 coupled to the controller 34, the speaker circuit 40 and the electronic device 16. The interface circuit 38 performs Ethernet packet transmission and reception with the electronic device 16 and provides the speaker circuit 40 with electrical signals suitable for being converted into sound. The interface circuit 38 also transfers and parses received data packets from the electronic device 16 to the controller 34 for further processing.

The illuminable assembly 14 also includes a pressure sensor circuit 30, a receiver circuit 32 and a pixel 36 coupled to the controller 34. The controller 34 provides further processing of the data packet sent by the electronic device 16 to determine which pixel 36 the electronic device 16 selected along with a color value for the selected pixel 36. The pressure sensor circuit 30 provides the controller 34 with an output signal having a variable frequency value to indicate the presence of a user on a portion of the illuminable assembly 14. The receiver circuit 32 interfaces with the physical object 12 to receive data frames transmitted by the physical object 12 and to transmit data frames to the physical object 12. The receiver circuit 32 processes and validates each data frame received from the physical object 12, as discussed above, and forwards the validated data frame from the physical object 12 to the controller 34 for transfer to the interface circuit 38.

In operation, the receiver circuit 32 receives data frames from each physical object 12 within a particular distance of the illuminable assembly 14. The receiver circuit 32 processes the received data frame, as discussed above, and forwards the received data to the controller 34. The controller 34 forwards the data from the receiver circuit 32 to the interface circuit 38 to allow the interface circuit 38 to form an Ethernet packet. Once the Ethernet packet is formed, the interface circuit 38 transfers the packet to the electronic device 16 for processing. The electronic device 16 processes the data packets received from the interface circuit 38 to identify the physical object 12 and determine a physical parameter of the identified physical object 12.

The electronic device 16 uses the source identification from the illuminable assembly 14 along with identification value received from the physical object 12 and optionally a velocity value from the physical object 12 to determine a current location of the physical object 12. Optionally, the electronic device 16 also determines a possible future location of the physical object 12. The electronic device 16 can also determine from the data provided a distance between each physical object 12 active in the system 10.

The electronic device 16, upon processing the data from the physical object 12, transmits data to the illuminable assembly 14 that instructs the illuminable assembly 14 to generate a suitable output, such as a visual output or an audible output or both. Optionally, the electronic device 16 also transmits data to the identified physical object 12 to instruct the physical object 12 to generate a suitable output, for example, a visual output, a vibrational output or both.

The interface circuit 38 upon receipt of an Ethernet packet from the electronic device 16 stores it in chip memory and determines whether the frames destination address matches the criteria in an address filter of the interface circuit 38. If the destination address matches the criteria in the address filter, the packet is stored in internal memory within the interface circuit 38. The interface circuit 38 is also capable of providing error detection such as CRC verification or checksum verification, to verify the content of the data packet. The interface circuit 38 parses the data to identify the controller 34 responsible for controlling the selected pixel and transfers the appropriate pixel data from Ethernet packet to the identified controller 34. In addition, the interface circuit 38 is responsible for enabling the speaker circuit 40 based on the data received from the electronic device 16.

The illuminable assembly 14 allows the system 10 to advantageously detect and locate the physical object 12 even if the physical object 12 is not in direct contact with the illuminable assembly 14. As such, when a user attaches a physical object 12 to a portion of their footwear, the system 10 can detect the presence of the user's foot above one or more of the illuminable assemblies 14 and determine whether the user's foot is stationary or ill motion. If a motion value is detected, the system 10 can advantageously determine a direction in which the user's foot is traveling relative to a particular one of the illuminable assembly 14. As a result, the interactive system 10 can predict which illuminable assembly 14 the user is likely to step onto next and provide instructions to each possible illuminable assembly 14 to generate an output response, whether it is a visual or audible response to interact and entertain the user. Consequently, the system 10 can block the user from moving in a particular direction before the user takes another step. As such, the system 10 is able to track and interact with each user even if each pressure sensor circuit 30 becomes inactive or disabled in some manner.

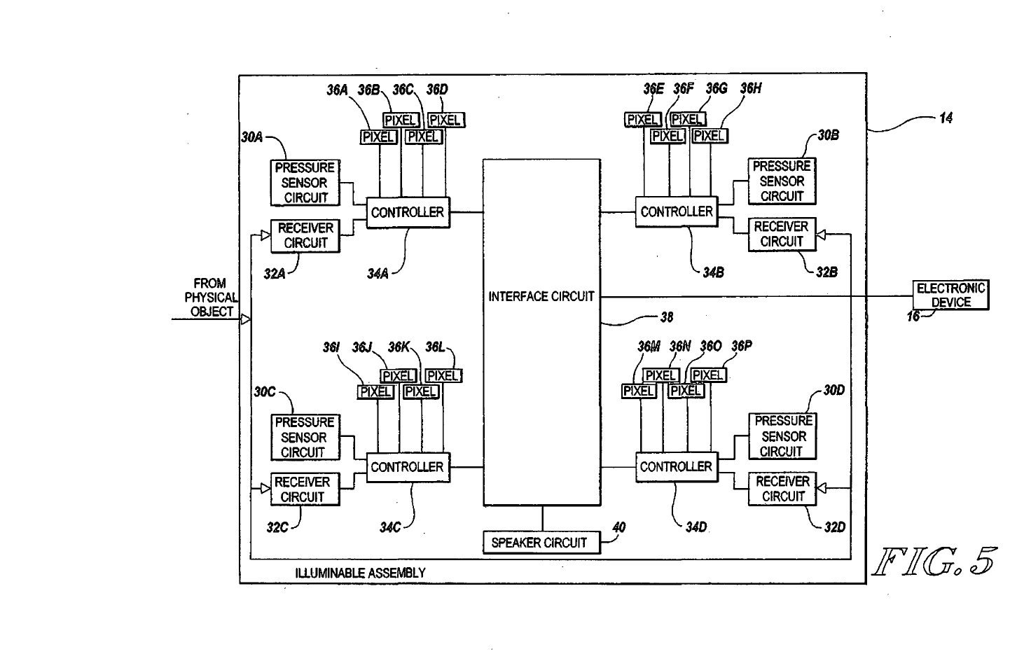

FIG. 5 illustrates the illuminable assembly 14 having more than one pixel 36 and more than one controller 34. The illuminable assembly 14 illustrated in FIG. 4 operates in the same manner and same fashion as described above with reference to FIG. 2 and FIG. 3. FIG. 5 illustrates that the illuminable assembly 14 is adaptable in terms of pixel configuration to ensure suitable visual effects in a number of physical locations. For example, the illuminable assembly 14 illustrated in FIG. 5 is divided into four quadrants. The first quadrant including the controller 34A coupled to the receiver 32A, the pressure sensor circuit 30A, pixels 36A-36D and the interface circuit 38. In this manner, the interface circuit 38 is able to parse data received from the electronic device 16 and direct the appropriate data to the appropriate controller 34A-34D to control their associated pixels. The configuring of the illuminable assembly 14 into quadrants also provides the benefit of being able to disable or enable a selected quadrant if one of the controllers 34A-36D or if one or more of the individual pixels 36A-36Q fail to operate properly.

FIG. 6 depicts the interface circuit 38 in more detail. The interface circuit 38 is adapted to include a physical network interface 56 to allow the interface circuit 38 to communicate over an Ethernet link with the electronic device 16. The interface circuit 38 also includes a network transceiver 54 in communication with the physical network interface 56 to provide packet transmission and reception. A first controller 52 in communication with the network transceiver 54 and chip select 50 (described below) is also included in the interface circuit 38 to parse and transfer data from the electronic device }6 to the controller 34.

The physical network interface 56 provides the power and isolation requirements that allow the interface circuit 38 to communicate with the electronic device 16 over an Ethernet compatible local area network. A transceiver suitable for use in the interface circuit 38 is available from Halo Electronics, Inc. of Mountain View, Calif. under the part number MDQ-001.

The network transceiver 54 performs the functions of Ethernet packet transmission and reception via the physical network interface 56. The first controller 52 performs the operation of parsing each data packet received from the electronic device 16 and determining which controller 34A through 34D should receive that data. The first controller 52 utilizes the chip select 50 to select an appropriate controller 34A through 34D to receive the data from the electronic device 16. The chip select 50 controls the enabling and disabling of a chip select signal to each controller 34A through 34D in the illuminable assembly 14. Each controller 34A through 34D is also coupled to a corresponding receiver circuit 32A through 34D. Receiver circuit 34A through 34D operate to receive data from the physical object 12 and forward the received data to the respective controller 34A through 34D for forwarding to the electronic device 16. Nonetheless, those skilled in the art will recognize that each receiver circuit is configurable to transmit and receive data from each physical object. The receiver circuits 34A through 34D are discussed below in more detail relative to FIG. 8.

In this manner, the first controller 52 is able to process data from the electronic device 16 in a more efficient manner to increase the speed in which data is transferred within the illuminable assembly 14 and between the illuminable assembly 14 and the electronic device 16. In addition, the use of the chip select 50 provides the illuminable assembly 14 with the benefit of disabling one or more controllers 34A through 34D should a controller or a number of pixels 36A through 36Q fail to operate properly. Those skilled in the art will recognize that the interface circuit 38 can be configured to operate without the chip select 50 and the first controller 52.

A controller suitable for use as the first controller 52 and the controller 34 is available from Microchip Technology Inc., of Chandler, Ariz. under the part number PIC 16C877. A controller suitable for use as the network transceiver 54 is available from Cirrus Logic, Inc. of Austin, Tex. under the part number CS8900A-CQ. A chip select device suitable for use as the chip select SO is available from Phillips Semiconductors, Inc. of New York under the part number 4AHC138.

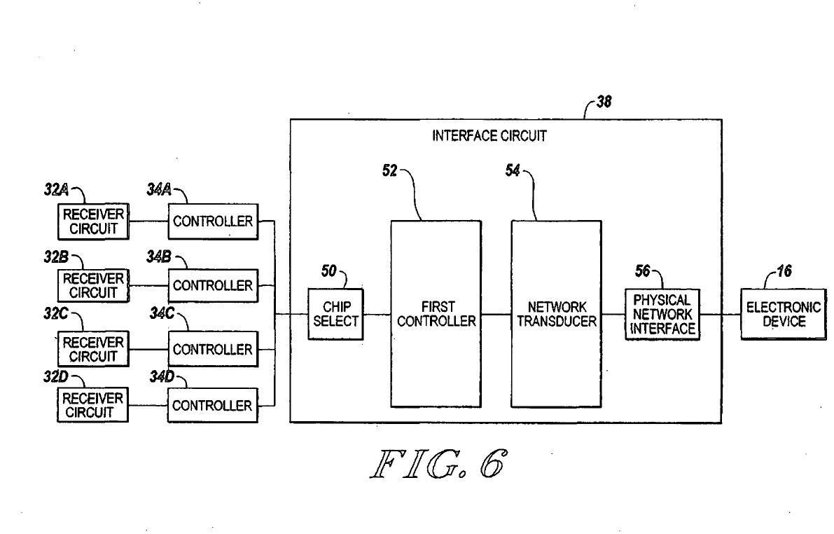

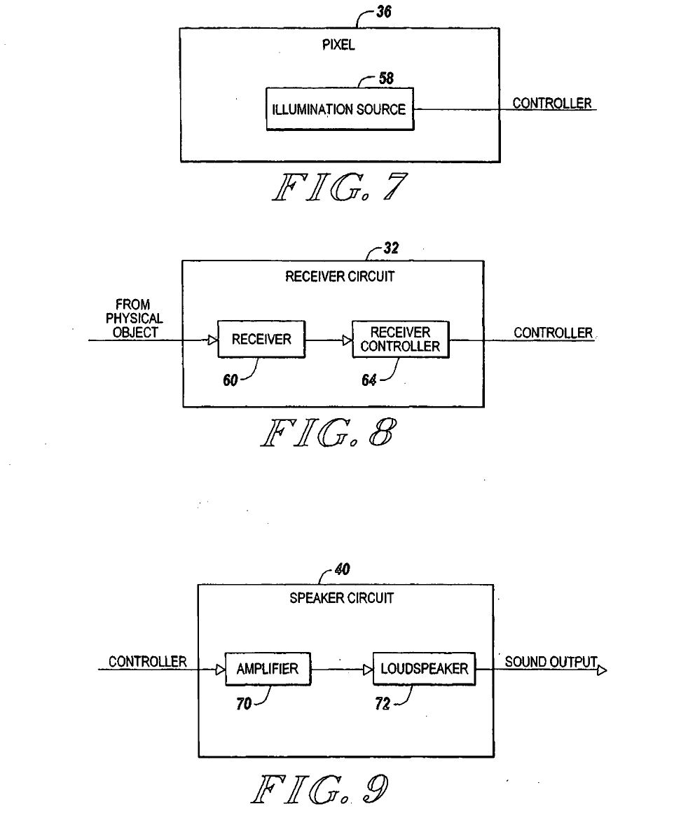

FIG. 7 illustrates the pixel 36 in more detail. The pixel 36 includes an illumination source 58 to illuminate the pixel 36. The illumination source 58 is typically configured as three light emitting diodes (LEDs), such as a red LED, a green LED and a blue LED. The illumination source 58 can also be configured as an Electro-Illuminasence (EL) back lighting driver, as one or more incandescent bulbs, or as one or more neon bulbs to illuminate the pixel 36 with a desired color and intensity to generate a visual output. The electronic device 16 provides the illuminable assembly 14 with data that indicates a color and illumination intensity for the illumination source 58 to emit. Those skilled in the art will recognize that other illumination technologies, such as fiber optics or gas charged light sources or incandescent sources are suitable for use as the illumination source 58.

The data that indicates the color and the illumination intensity of the illumination source 58 to emit are converted by the illumination assembly 14 from the digital domain to the analog domain by one or more digital to analog converters (DACs) (not shown). The DAC is an 8-bit DAC although one skilled in the art will recognize that DAC's with higher or lower resolution can also be used. The analog output signal of the DAC is fed to an operational amplifier configured to operate as a voltage to current converter. The current value generated by the operational amplifier is proportional to the voltage value of the analog signal from the DAC. The current value generated by the operational amplifier is used to drive the illumination source 58. In this manner, the color and the illumination intensity of the illumination source 58 is controlled with a continuous current value. As such, the system 10 is able to avoid or mitigate noise issues commonly associated with pulse width modulating an illumination source. Moreover, by supplying the illumination source 58 with a continuous current value, that current value for the illumination source 58 is essentially latched, which, in turn, requires less processor resources than an illumination source receiving a pulse width modulated Current signal.

FIG. 8 illustrates the receiver circuit 32 in more detail. The receiver circuit 32 is configured to include a receiver 60 to receive data from the physical object 12 and a receiver controller 64 to validate and transfer the received data to the controller 34. In more detail, the receiver 60 is an infrared receiver that supports the receipt of an infrared signal carrying one or more data frames. The receiver 60 converts current pulses transmitted by the physical object 12 to a digital TTL output while rejecting signals from sources that can interfere with operation of the illuminable assembly 14. Such sources include sunlight, incandescent and fluorescent lamps. A receiver suitable for use in the receiver circuit 32 is available from Linear Technology Corporation of Milpitas, Calif. under the part number LT1328.

The receiver controller 64 receives the output of the receiver 60, identifies the physical object 12 that transmitted the data frame and optionally validates the frame by confirming a CRC value or a checksum value, or other error detection value sent with the frame. Once the receiver controller 64 verifies the data frame, it forwards the data frame to the controller 34 for transfer to the electronic device 16. A receiver controller suitable for use in the receiver circuit 32 is available from Microchip Technology Inc., of Chandler, Ariz. under the part number PIC16C54C.

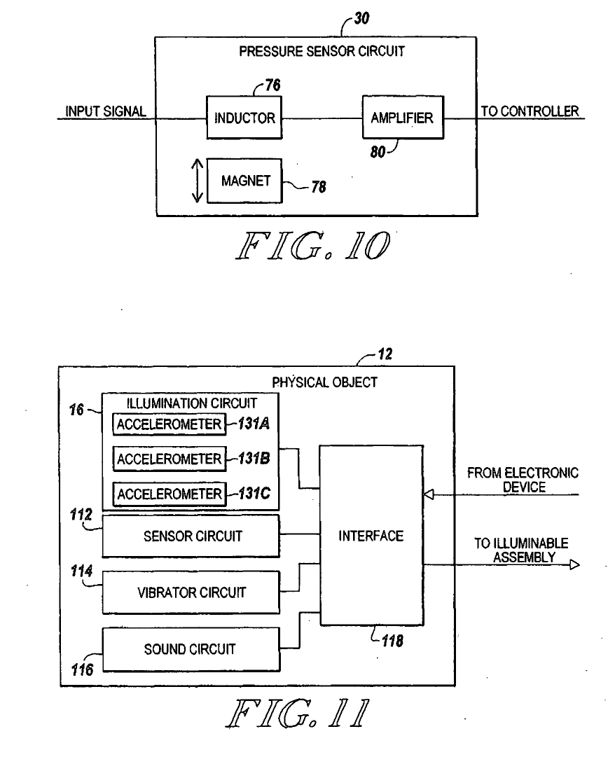

FIG. 9 illustrates the speaker circuit 40 for generating an audible output to heighten a user's senses. The speaker circuit 40 is adapted to include an amplifier 70 and a loudspeaker 72. The amplifier 70 is an audio amplifier that amplifies an audio input signal from the interface circuit 38 to drive the loudspeaker 72. The loudspeaker 72 converts the electrical signal provided by the amplifier 70 into sounds to generate an audible output. Those skilled in the art will recognize that the audible output can be generated in oilier suitable manners) for example, wireless headphones worn by each user. Moreover, those skilled in the art will recognize that the illuminable assembly 14 forms housing for the loudspeaker 72.

FIG. 10 illustrates the pressure sensor circuit 30 in more detail. The pressure sensor circuit 30 includes an inductor 76, a magnet 78, and an amplifier 80. The inductor 76 is located in a magnetic field of the magnet 78 and coupled to the amplifier 80. The inductor 76 and the amplifier 80 form an oscillator circuit that oscillates at a base frequency of about 200 kHz. The magnet 78 moves upward and downward in a plane perpendicular to the inductor 76 so that the magnetic forces exerted by the magnet 78 on the inductor 76 vary with the movement of the magnet 78. The upward and downward movement of the magnet 78 is based on the amount of pressure a user exerts on a portion of the illuminable assembly 14. As such. The magnetic force exerted by the magnet 78 on the indicator 76 varies with the movement of the magnet 78 to cause the frequency of the oscillator circuit to vary. The oscillator circuit formed by the indicator 76 and the amplifier 80 provide the controller 34 with an output signal that indicates a pressure value exerted on at least a portion of the illuminable assembly 14 by one or more users.

FIG. 11 illustrates the physical object 12 in more detail. The physical object 12 includes an interface circuit 118 to communicate with the electronic device 16 and the illuminable assembly 14. The physical object 12 also includes an illumination circuit 110 in communication with the interface circuit 118, a sensor circuit 112, a vibrator circuit 114 and a sound circuit 116. The illumination circuit 110 provides a visual output, to illuminate the physical object 12. The sensor circuit 112 measures a physical stimulus of the physical object 12, such as motion of the physical object 12 in an X-axis, Y-axis and Z-axis and provides the interface circuit 118 with a response that indicates an acceleration value of the physical object 12 in at least one of the three axis's. The vibrator circuit 114 is capable of generating a vibrational output when enabled by the interface circuit 118 to provide an output capable of heightening one of the user's senses. The sound circuit 116 is also under the control of the interface circuit 118 and is able to generate an audible output.

The illumination circuit 110 typically includes three LED's (not shown) such as a red, blue and green LED to illuminate the physical object 12 when enabled by the interface circuit 118. Those skilled in the art will recognize that the illumination circuit 110 can include more than three LED' or less than three LED's. Moreover, those skilled in the art will appreciate that the illumination circuit 100 can include an Electro Illuminasence(EL) back lighting driver, one or more incandescent bulbs, or one or more neon bulbs to generate the visual output or other illumination technologies.

The sensor circuit 112 typically includes three accelerometers (accelerometers 131A-131C) or in the alternative, three inclinometers to measure a physical stimulus on the physical object 12. The sensor circuit 112 is capable of sensing the physical stimulus in one or more of three axis's, for example, an X-axis, a Y-axis and a Z-axis, and provide a response to the interface circuit 118 that indicates an acceleration value of the physical object 12 in at least one of the three axes. In the alternative, if the sensor circuit 112 is adapted with one or more inclinometers (not shown) then the sensor circuit 112 provides a response to the interface circuit 118 that indicates the inclination of the physical object 12 relative to the horizontal of at least one of three axes. Those skilled in the art will recognize that the physical object 12 can be adapted to include other sensor elements or sensor like elements, such as a gyroscope capable of providing angular information or a global positioning system.

The vibrator circuit 114 includes a mechanism (not shown), such as motor that generates vibrational force when enabled by the interface circuit 118. The vibrational force generated by the vibrator circuit 114 having a sufficient force, duration and frequency to allow a user to sense the vibration when the physical object 12 is coupled to the user's foot ware.

The sound circuit 116 includes a loudspeaker (not shown), and optionally includes an amplifier to amplify an electrical signal provided by the interface circuit 118 and drive the loudspeaker with an amplified signal. The loudspeaker allows the physical object 12 to generate a sound output when directed to do so by the electronic device 16 or by the illuminable assembly 14.

The physical object 12 is provided with a unique serial number that is used by the interactive system 10 to identify the physical object 12. The unique serial number of the physical object 12 can be associated with a particular user through a user profile, a user account, a user name, or other like data record so as to select a game or activity the user wishes to participate in, or to track an amount of system use by the user.

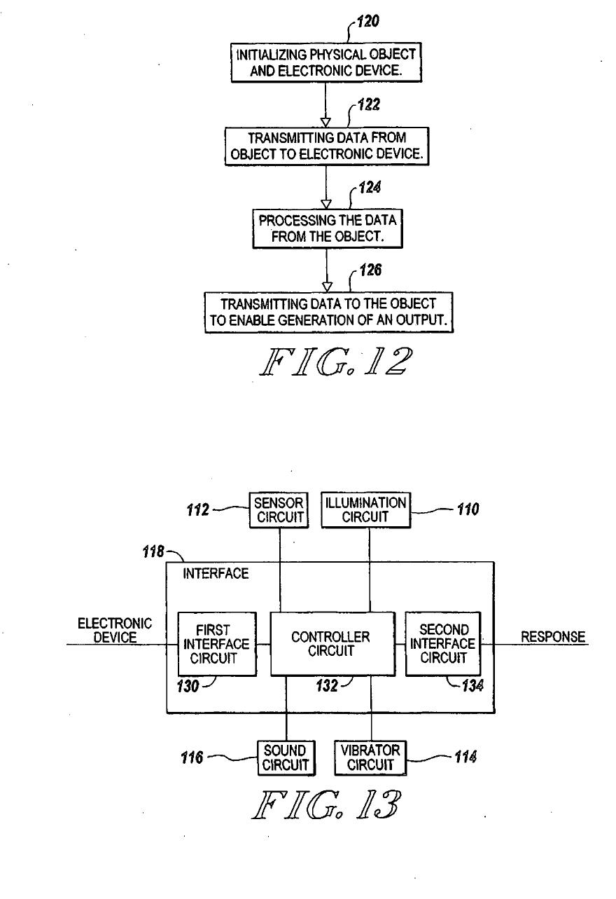

FIG. 12 illustrates the steps taken to operate the physical object 12 in the system 10. The physical object 12 at power up performs a self-diagnostic routine. Upon completion of the self-diagnostic routine, the physical object 12 awaits a frame synchronization pulse from the electronic device 16 (step 120). Once the physical object 12 is synchronized with the electronic device 16, the physical object 12 transmits a data frame to provide the electronic device 16 with indicia that identifies that particular physical object 12 (step 120). Once the electronic device 16 receives the identification from the physical object the electronic device 16 can assign the physical object 12 a new identification if a conflict is detected amongst other physical objects, otherwise, the electronic device 16 utilizes the provided identification to communicate with the physical object 12. Each data packet transmitted by the electronic device 16 to one of the physical objects 12 includes a unique identifier that identifies the intended physical object 12. The unique identifier is typically the physical object's unique identification unless it is reassigned. (Step 120).

In operation, the physical object 12 communicates with the electronic device 16 via the illuminable assembly 14 in its assigned time slot to provide the electronic device 16 with the response from the sensor circuit 112 (step 122). The electronic device 16 processes the response data provided by the physical object 12 to determine at least a current location of the physical object 12 relative to a selected illuminable assembly 14 (step 124). If desired, the electronic device 16 can determine a location of a selected physical object 12 relative to one or more other physical objects 12. Those skilled in the art will recognize that the illuminable assembly can be configured to transmit data to the physical object 12 in a wired or wireless manner or to communicate directly with the electronic device 16 without having to first interface with the illuminable assembly 14. Moreover, those skilled in the art will recognize the physical object 12 can be configured to communicate with other physical objects in a wired or wireless manner. Nevertheless, those skilled in the art will recognize that the physical object 12 and the illuminable assembly 14 communicate in a manner that does not interfere with communications between other physical objects and illuminable assemblies.

Once the electronic device 16 determines a location of the physical object 12, the electronic device 16 is able to instruct the physical object 12 to generate an output based on an analysis of various system variables (step 126). Possible variables include, but are not limited to, number of users, location of the physical object 12, velocity of the physical object 12, and type of entertainment being provided, such as an aerobic exercise.

FIG. 13 illustrates the interface circuit 118 in more detail. The interface circuit 118 includes a first interface circuit 130 in communication with controller circuit 132, which, in turn, is in communication with a second interface circuit 134. The controller circuit 132 is also in communication with the illumination circuit 110, the sensor circuit 112, the vibrator circuit 114 and the sound circuit 116. The first interface circuit 130 also communicates with the electronic device 16 while the second interface circuit 134 also communicates with the illumination circuit 110, the sensory circuit 112, the vibrator circuit 114 and the sound circuit 116.

The first interface circuit 130 operates to receive and condition the data transmitted by the communication module 18 from the electronic device 16. Once the first interface circuit 130 receives and condition. ˜the data from the electronic device 16, the first interface circuit 130 transfers the data to the controller circuit 132 for further processing. The controller circuit 132 processes the received data to coordinate operation of the illumination circuit 110, the sensor circuit 112, the vibrator circuit 114 and the sound circuit 116 within the physical object 12. The controller circuit 132 also processes the response from the sensor circuit 112 by digitizing the data and to coordinate transmission of the sensor response during the assigned data frame. The second interface circuit 134 transmits a data packet to the illuminable assembly 14 to provide the electronic device 16 with the response from the sensor circuit 112. A controller suitable for use as the controller circuit 132 is available from Microchip Technology Inc., of Chandler, Ariz. under the part number PIC16C877.

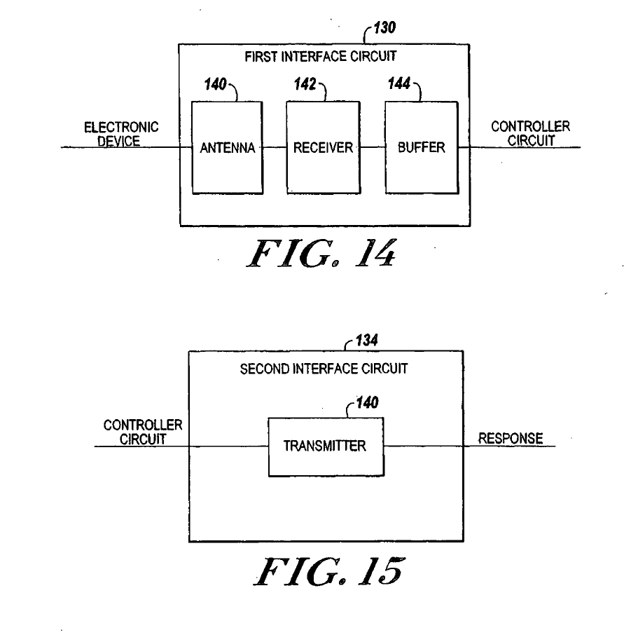

FIG. 14 illustrates the first interface circuit 130 in more detail. The first interface circuit 130 includes an antenna 140 in communication with a receiver 142. The receiver 142 is also in communication with a buffer 144. The antenna 140 receives the data transmitted by the electronic device 16 via the communication module 118 and forwards that data to the receiver 142. The receiver 142 processes and conditions the received data by converting it from an analog state to a digital state before the data is transferred to the buffer 144. The buffer 144 buffers the data from the receiver 142 to minimize the influence of the receiver circuit 142 on the controller circuit 132. A receiver suitable for use in the first interface circuit 142 is available from RF Monolithics, Inc. of Dallas, Tex. under the model number DR5000.

FIG. 15 illustrates the second interface circuit 134 in more detail. The second interface circuit 134 includes a transmitter 140 to transmit the response from the sensor circuit 112 to the illuminable assembly 14. The transmitter circuit 140 includes one or more infrared LED's to transmit the response using an infrared output signal suitable for receipt by the receiver circuit 32 within the illuminable assembly 114.

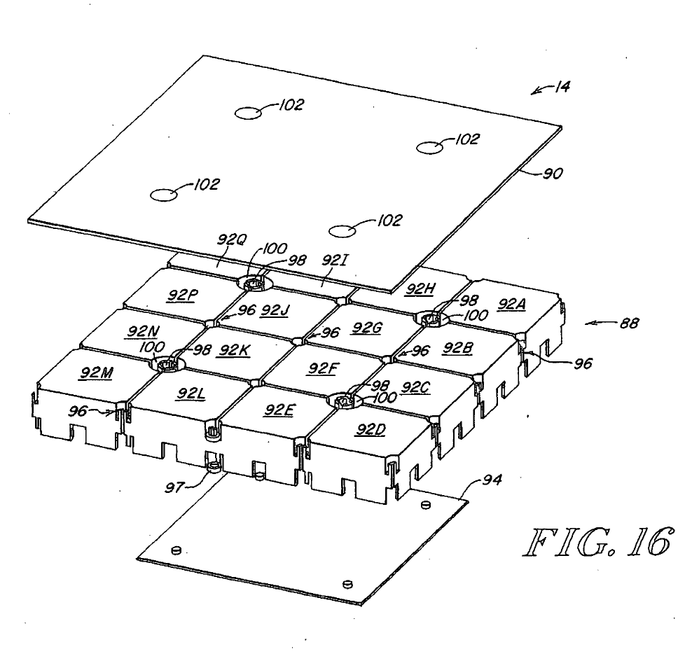

FIG. 16 illustrates a mechanical layout of the illuminable assembly 14. The illuminable assembly 14 includes a top portion 90, a mid-portion 88 and a base portion 94. The top portion 90 includes a filter portion 102 that operates in conjunction with the receiver circuit 32 to attenuate frequencies outside of the receiver's frequency range. The top portion 90 is manufactured from a material having translucent properties to allow light to pass through. Top portion 90 operates as a protective layer to the mid-portion 88 to prevent damage to the mid-portion 88 when a user steps onto the illuminable assembly 14. The top portion 90 can be configured as an assembly having a continuous side profile or as an assembly having a layered side profile that represents a plurality of disposable layers that can be removed as a top layer becomes damaged or dirty. The top portion 90 also serves as a mechanical base to hold one or more magnets for use in conjunction with one or more of the pressure sensor circuits 10 discussed above in more detail.

The mid-portion 88 include pixel housings 92A through 92Q that house pixels 36A through 36Q. Pixel housings 92A through 92Q are of uniform shape and size and are interchangeable with one another. Each pixel housing 92A through 92Q may be molded out of a polycarbonate material of suitable strength for supporting the weight of a human being. The pixel housings are grouped as a set of four housings, for example, 92A, 92B, 920 and 92H. When four pixel housings, such as 92A, 92B, 920 and 92H are coupled they form a first radial housing 98 and a second radial housing 100 at a location where all four pixel housings contact each other. The first radial housing 98 houses a portion of the receiver 60, discussed in detail above. The second radial housing 100 houses the magnet 78 discussed in detail above. Each pixel housing 92A through 92Q also include a portion adapted to include a fastener portion 96 to receive a fastening mechanism, such as fastener 97 to secure each pixel housing 92A through 92Q to each other and to the base portion 94. Nonetheless, those skilled in the art will recognize that the mid-portion 88 can be formed as a single unit.

The base portion 94 has the pressure sensor circuit 30, the receiver circuit 32, the control circuit 34, the interface circuit 38 and the speaker circuit 40 mounted thereto. Also mounted to the bottom portion 94 are the various interconnections that interconnect each of the components illustrated in the illuminable assembly 14 of FIGS. 4 and 5.

Typically, the illuminable assembly 14 is configured as a square module having a length measurement of about sixteen inches and a width measurement of about sixteen inches. The mid-portion 88 is typically configured with sixteen pixel housings 92A through 92Q to house sixteen pixels 36A through 36Q, four receivers 32 and four magnets 78. Nevertheless, those skilled in the art will recognize that the illuminable assembly 14 can be configured to have a smaller overall mechanical footprint that would include a smaller number of pixel housings, such as four pixel housings or less, or in the alternative, configured to have a larger overall mechanical footprint to include more than sixteen pixel housings, such as twenty-four pixel housings, or thirty-two pixel housings or more. Moreover, the illuminable assembly 14 facilitates transportability of the system 10, to allow the system 10 to be transported from a first entertainment venue to a second entertainment venue without the need for specialized tradesmen.

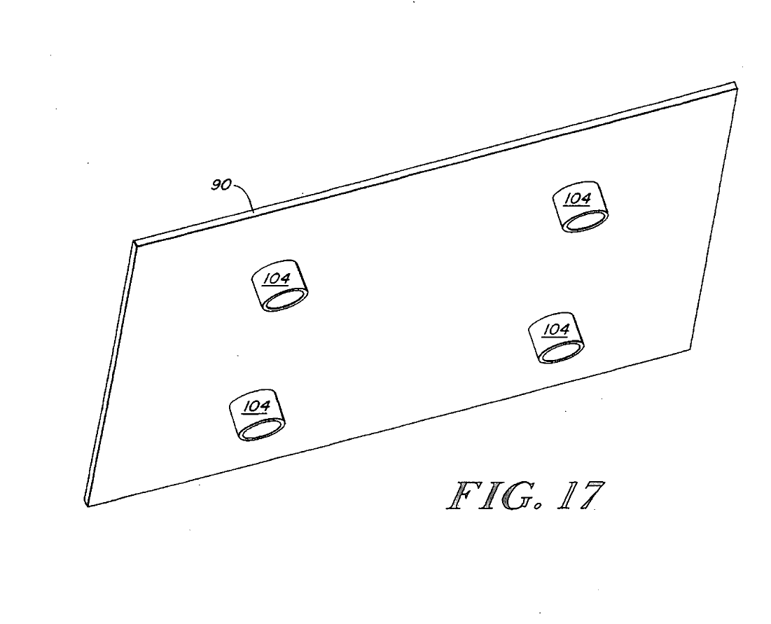

FIG. 17 illustrates a bottom side of the top portion 90. As illustrated, the top portion 90 is configured with one or more support columns 104. The support columns 104 are sized to fit within the second radial housing 100. The support columns 104 provide support for the top portion 90 when placed in communication with the mid-portion 88. Each support column 104 includes a diameter and a wall thickness compatible with a diameter and opening distance of the second radial housing 100 located in the mid-portion 88. Typically, each support column 104 moves upward and downward in a vertical direction within the second radial housing 100 and rests upon a flexible surface inserted into the second radial housing 100. Each support column 104 is also coupled with the magnet 78 (not shown) so that the magnet 78 moves in an upward and downward direction with the support column 104. The coupling of the magnet 78 to each support column 104 allows each pressure sensor circuit 30 to detect a magnitude of pressure exerted by a user on a portion of the illuminable assembly 14.

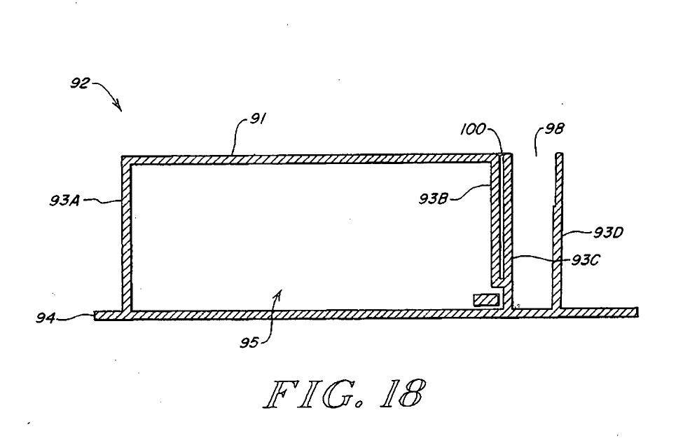

FIG. 18 illustrates a side view of a pixel housing 92. As illustrated, each pixel housing 92 includes a first side portion 93A in contact with the bottom portion 94 of the illuminable assembly 14, a second side portion 93B and a third side portion 93C that form a portion of the second radial housing 100. The third side portion 93C and a fourth side portion 93D also contact the bottom portion 94 of the illuminable assembly 14 to provide additional support for the pixel housing 92. The third side portion 93C and fourth side portion 93D form a portion of the first radial housing 98. Each pixel housing 92 also includes a top portion 91. FIG. 18 also illustrates a suitable location of the inductor 76 discussed above with reference to FIG. 10. Each pixel housing 92 includes an open bottom portion 95 to fit over the illumination source 58 discussed above with reference to FIG. 7.

The pixel housing 92 provides a low cost durable housing that can be used in any location through out the mid-portion 88. As a result, a damaged pixel housing 92 within the mid-portion 88 can be replaced in a convenient manner. As a result, the illuminable assembly 14 provides a repairable assembly that minimizes the need to replace an entire illuminable assembly 14 should a pixel housing 92 become damaged.

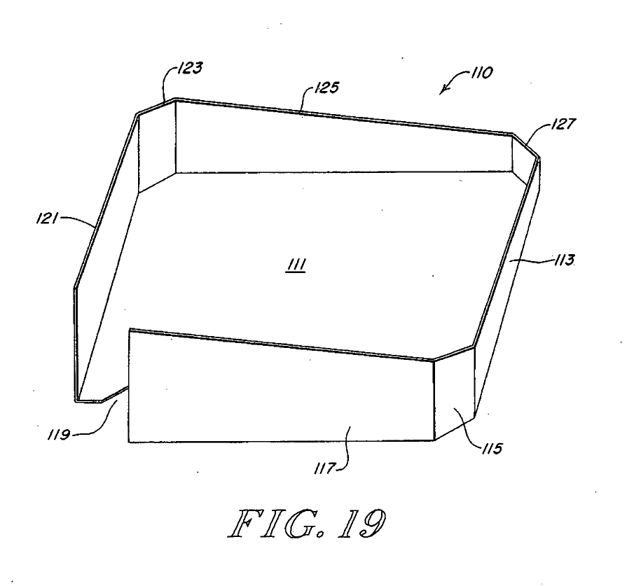

FIG. 19 illustrates a diffuser element 110 suitable for use with each of the pixel housings 92A through 92Q to diffuse light emitted by the illumination source 58. The diffuser element 110 helps assure that light emitted from the illumination source 58 exhibits a uniform color and color intensity across the entire top portion 91 of the pixel housing 92. The diffuser element 110 fits within the pixel housing 92 and includes an opening 119 to receive the illumination source 58. The diffuser element 110 includes a bottom portion 111 that reflects light emitted from the illumination source 58 upward towards the top portion 91 of the pixel housing 92 for projection through the top portion 90 of the illuminable assembly 14.

The diffuser element 110 also includes a first tapered side portion 117 connected to a first mitered comer portion 115, which is connected to a second tapered side portion 113. The second tapered side portion 113 is also connected to a second mitered comer portion 127, which is connected to a third tapered side portion 125. The third tapered side portion 125 is also connected to third mitered corner portion 123, which is connected to a fourth tapered side portion 121. The diffuser element 110 includes an open top portion.

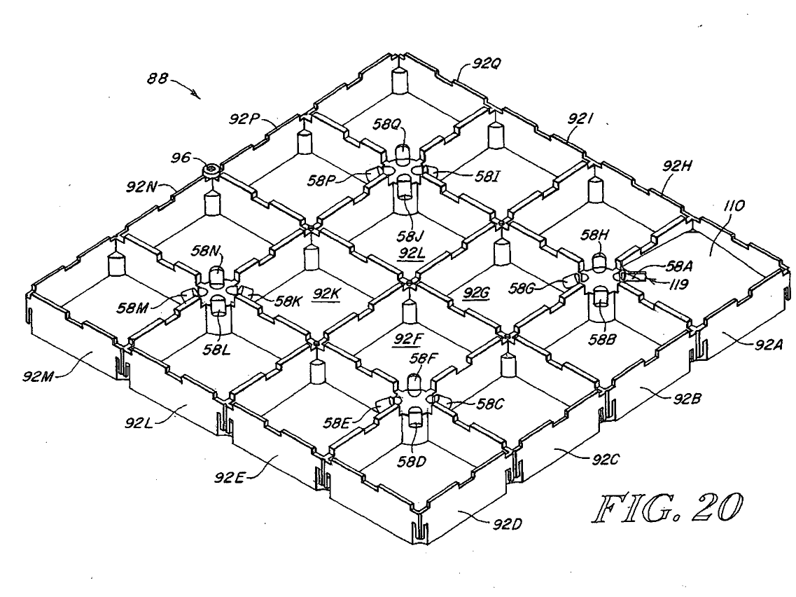

FIG. 20 provides a bottom view of the mid-portion 88. In more detail, the diffuser element 110 is inserted into the bottom portion of the pixel housing 92 as indicated by pixel housing 92A. Illumination element 58A fits through the opening 119 to illuminate the pixel housing 92A when enabled. FIG. 20 also illustrates the advantageous layout of the illuminable assembly 14 to minimize the length of the interconnections that are used to operate the illuminable assembly 14. Moreover, the configuration of the pixel housing 92 allows for interchangeable parts and significantly reduces the possibility of manufacturing errors during the manufacture of the illuminable assembly 14.

The illustrative embodiment of the present invention tracks the location of one or several physical objects relative to the illuminable assembly 14 (i.e.: the playing surface) of the illuminable system 10. The position of the physical object or objects is tracked by interpreting the data sent from the receivers located in the illuminable assembly 14 to the electronic device 16. Specifically, which receivers receive a signal from the physical object as opposed to which receivers do not receive a signal is used to determine the location of the physical object relative to the illuminable assembly 14.

In one embodiment, a physical object that is approximately the size of a standard computer mouse is affixed to the shoe of a user of the system 10. The physical object includes three signal transmitters located on the exterior edge of the physical object. The signal transmitters are located so as to project a signal away from the physical object. The three signal transmitters are positioned approximately equal distances away from each other so as to send signals out approximately every 120* around the exterior of the physical object. As the user moves relative to the illuminable assembly 14, the signal pattern also moves with different receivers receiving the signals generated by the signal transmitters. Additionally, the orientation of the physical object relative to the illuminable assembly impacts which receivers pick up a signal. For example, if a user is running and the toe of a shoe is pointing downwards, the third transmitter may generate a signal directly away from the illuminable assembly 14 which will not be picked up resulting in only two patterns picked up by the receivers of the illuminable assembly. Those skilled in the art win ˜recognize that the number of signal transmitters may be more or less than the three transmitters described herein, and that the positioning of the signal transmitters on the physical object may vary without departing from the scope of the present invention.

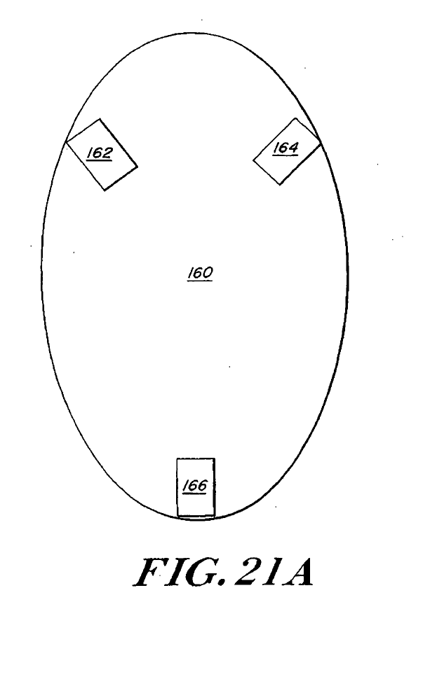

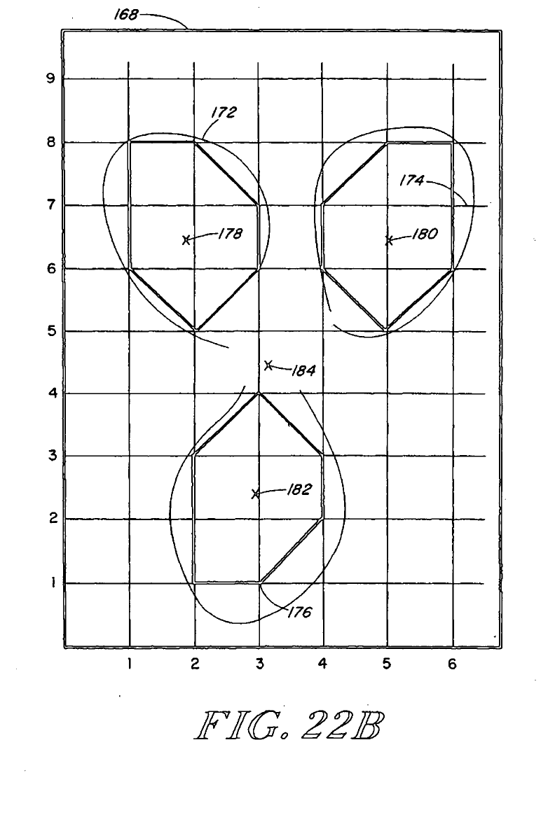

FIG. 21 A depicts a physical object 160 about the size of a computer mouse. The physical object 160 includes signal transmitters 162, 164 and 166 which are spaced at approximately equal distances from each other around the exterior of the physical object 160. The signal transmitters 162, 164 and 166 generate signals directed away from the physical object 160 which are detected by receivers in the illuminable assembly 14.

The receivers on the illuminable assembly 14 that receive ˜the signal from the transmitters 162,164 and 166 inform the electronic device 16. The locations of the receivers that register a signal form a pattern on the illuminable assembly 14. The patterns are programmatically analyzed to produce an estimation of the physical object's current location and optionally an expected future course. The illustrative embodiment of the present invention also compares the signal ID with previous determined locations and parameters to verify the current location (i.e.: a physical object on a shoe cannot move greater than a certain distance over the chosen sampling time interval). The illuminable assembly 14 is mapped as a grid 168 marked by coordinates (see FIG. 21B below).

FIG. 21 B depicts the grid 168 with three superimposed patterns 172, 174 and 176 that have been detected by the receivers of the illuminable assembly 14. Each receiver that registers the signal sent from the transmitters is plotted on the grid 168, with the pattern being formed by connecting the exterior receiver coordinates. Each adjacent exterior coordinate is connected to the next exterior coordinate by a line segment. The patterns in this case are all equal in size and density and are therefore produced by a physical object either on, or horizontally oriented to, the illuminable assembly 14. The patterns 172, 174 and 176 are analyzed to determine the centers 178, 180 and 182 of each of the patterns. The center of the patterns 178, 180 and 182 represent the center of the respective signal paths are utilized to determine the origin of the signal 184 (i.e.: the position of the physical object 160). Analog signal strength can also be used to enhance the estimation of the signal origin by using the physical principle that the strength will be greater closer to the signal source. In the present embodiment, a digital signal is used to reduce the need to process signal noise.

The system 10 determines the coordinates on the grid 168 of the receivers that receive the transmitters 162, 164 and 166 signal in order to establish a pattern. The process is similar to placing a rubber band around a group of nails protruding out of a piece of wood (with the position of the responding receivers corresponding to the nails). The rubber band forms a circumference pattern. Similarly, the receiver pattern is formed by drawing a line on the grid 168 connecting the coordinates of the exterior responding receivers. The adjacent exterior coordinates are connected by line segments. Some receivers within the pattern may not respond, perhaps due to a contestant in a game standing on the receiver and blocking the signal, or because of malfunction. For the purposes of determining the center of the pattern, non-responding receivers within the pattern are ignored. A weighted average of the external line segments is calculated in order to determine the center coordinates of the pattern. Longer line segments are given proportionally more weight. Once the center of the pattern 172 has been calculated, probability zones are established for a probability density function by computing the angles each exterior coordinate point makes from the center. A similar process is then followed to for the other patterns 174 and 176.

Following the calculation of the centers of the three patterns 172, 174 and 176, the center coordinates 178, 180 and 182 of the three patterns are averaged to make a rough prediction of the position of the physical object 160. This rough location prediction is then used in a sampling algorithm which tests a probability density function (PDF) of the object's location points in expanding concentric circles out from the rough prediction center point. The PDF is a function that has an exact solution 0 given the physics of the signals involved and models of noise and other factors. Given enough computational power, an optimal PDF can be computed.

In the present embodiment, approximations are used to make the computation more efficient. The following approximations and models are used in the present embodiment. Using the probability zones already computed, a sample point is first categorized into a zone by examining the vector angle the point makes with respect to the pattern center. Next, it is determined whether the point lies within the bounding pattern circumference. If the point is located within the bounding pattern circumference, a much smaller variance value is used in computing a normal probability density function that drops off as the sample point to line segment distance increases. This function represents the ideal physical principle that the signal source is most likely to be close to the edge of the signal pattern. If the signal source were farther away, additional receivers would have seen the signal, and if the signal source was closer in to the center of the pattern, the signal would have to travel backwards.

Since it is assumed there is noise in the environment, this physical principle is modeled noisily using a probabilistic approach. This algorithm also assumes a directional signal, and the direction of the signal implies an orientation angle to the physical object. Given an established probability zone, the sample point to pattern center angle is used as an additional probability factor in estimating object orientation angle. The probability function drops off as the possible orientation angle differs from the sample point to pattern center angle. Given multiple signal patterns, a sample point's PDF is computed for each pattern and multiplied together to compute an overall PDF. By using the fact that the physical object can have only one orientation angle, each PDF s orientation angle must be coordinated with the others (e.g., if the signal directions are 120 degrees apart. the angles used in the PDF must be 120 degrees apart). Either integrating over all possible angles or using just the average best angle may be used in computing the overall PDF.

The sampling algorithm multiplies the probability given the x and y center coordinates (which represent the distance from the edge of the illuminable assembly 14) and the angle between the center coordinates and the position of the physical object for the first pattern, by the probability given the x and y center coordinates and the angle between the center coordinates and the position of the physical object for the second and third patterns to get an overall value.

When the sampling algorithm returns a value that is less than 1% of the highest value seen so far after exploring a minimum number of sampling rings, it stops and the highest value or PDF-weighted average of a set of highest values is chosen as the x. y coordinates representing the position of the physical object 160. Those skilled in the art will recognize that once a final position has been calculated for the physical object 160, it may be further verified by resorting to additional information including the historical position of the physical object and pressure readings from pressure sensors embedded in the floor of the illuminable assembly. In an alternative embodiment, the location may be calculated solely from pressure readings, accelerometer readings, or a combination or receiver patterns, accelerometer readings, historical data and pressure readings, or gyroscope readings. Further, each of these pieces of information imply a PDF on locations for the object, and may be multiplied together when available in a similar algorithm to that described for the directional signal algorithm to achieve a final probabilistic estimation.

Once a final position has been determined, the orientation of the physical object 160 is calculated. The orientation is calculated utilizing a number of factors either alone or in combination including the known range of the transmitters. The receiving abilities of the receivers, accelerometer readings from an accelerometer attached to the physical object 1 60, gyroscope readings from a gyroscope attached to the physical object, and the width of the transmitted signal. The orientation calculation determines the relative probability that the physical object is oriented in a particular position by testing orientation values capable of producing the detected patterns.

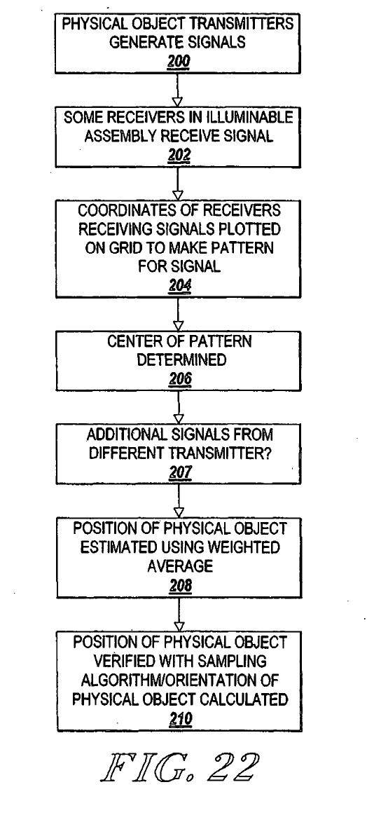

The sequence of steps followed by the illustrative embodiment of the present invention is depicted in the flowchart of FIG. 22. The sequence begins when the physical object transmitters on a physical object generate signals (step 200). Some of the receivers in the illuminable assembly receive the signals (step 202) and report the signal to the electronic device 16. The surface of the illuminable assembly 14 is represented as a grid 168 and coordinates corresponding to the location of the receivers detecting signals are plotted on the grid (step 204). Each signal is identified by a physical object ID and transmitter ID and the coordinates form a pattern when mapped on the grid 168. The center of the signal pattern is determined as discussed above (step 206). If more than one signal is detected (step 207) the process iterates until centers of each pattern have been determined. A weighted average is then applied to estimate an overall source of the signal where the signal corresponds to the position of the physical object 160 (step 208).

Error checking may be performed to determine the accuracy of the predicted position by using historical data and comparing predictions based on parameters (i.e.: a runner doesn't travel 50 yards in one second and a left and right shoe object should not be separated by 15 feet). Once the position of the physical object 160 has been roughly estimated, a PDF sampling algorithm is applied starting at the rough estimate to more accurately estimate the position and the orientation of the physical object to the illuminable assembly (step 210). A combination of accelerometer readings, historical data, pressure readings, gyroscope readings or other available location data may also be used to provide additional parameters to the PDF for more accuracy.

The system 10 tracks the current location of the physical object 160 so that it can reference the location of the physical object when sending commands to the illuminable assembly 14. The commands may be instructions for the generation of light displays by LED's embedded in the illuminable assembly 14. The commands sent from the electronic device 16 via the transmitters may include instructions for the generation of light at the current location of the physical object 160 or at a location offset from the current location of the physical object. The light display may be white light or a colored light with the color indicated in a separate field in the command (i.e. separate command fields for the red, blue and green diodes in an RGB diode which hold instructions for the signal intensity for each separate colored diode). Alternatively, the commands sent from the electronic device may relate to the generation of audio effects by different portions of the system 10 relative to the current location of the physical object 160. For example, during a game, the illuminable assembly may emit sound with each step of a player wearing the physical object 160. Alternatively, the game may require the player to change direction in response to sounds emanating from a remote region of the illuminable assembly 14. A physical object attached to a ball (or a ball which is the physical object) may cause the generation of noise or tight shadowing the path of the ball as the ball is thrown above the surface of the illuminable assembly 14.

In another embodiment, the position of the physical object 160 is determined based upon the strength of the signal received by the receivers in the illuminable assembly 14. The position of the physical object 160 is triangulated by comparing the signal strength from different receivers. Those skilled in the art will recognize that are a number of ways in which the illustrative embodiment of the present invention may determine the current location of the physical object 160. The physical object 160 may contain only one or two signal transmitters instead of three transmitters. The signal transmitters may be arranged in different orientations that are not equidistant from each other on the physical object 160 so as to create special patterns among the receivers that are recognizable by the electronic device. Additionally, the physical object 160 may be larger or smaller than the examples given herein without departing from the scope of the present invention.

In one embodiment of the present invention, the location of the physical object 160 is determined solely through the use of pressure sensors in the illuminable assembly 14. Sensors in the illuminable assembly 14 report pressure changes to the electronic device 16. A clustering algorithm determines the location of the physical object 160 by grouping pressure reports into clusters of adjacent coordinates. The coordinates are sorted from readings of the most pressure to the least pressure. The pressure readings are then examined sequentially, starting with the highest pressure reading. If the pressure reading is next to an existing cluster, it is added to the cluster. Otherwise, the pressure reading is used to start a new cluster, until all readings have been passed through. The physical principle underlying this algorithm is that a single pressure source will result in strictly monotonically decreasing pressure readings away from the center of the pressure source. Therefore, if pressure readings decrease and then increase along a collinear set of sensors, it must be caused by more than one pressure source. An assumption is made that a foot is not more than 16 inches long, so that if the cluster spans more than three grid coordinates it is assumed that it represents more than 1 foot.

The pressure readings for each cluster are added to get total weight being applied to the cluster. The total weight serves as an indicator as to whether the physical object 160 is landing, rising or staying still. Those skilled in the art will recognize that the pressure clustering algorithm may also be used in combination with other location methods including those outlined above rather than as the only location procedure. Additionally, these pressure location estimations are used to coordinate the location estimations of the device described previously with the state of the device or device-connected limb applying pressure or not to the surface. The pressure location technology may be also employed by itself as a basis for applications that do not require the tracking device at all, but rather only the applied pressure to the surface by the user or other objects.

The system 10 is further capable of interfacing with one or more applications designed to perform a specific function in the system, such as execution of a game. The electronic device 16 controls and manages the system 10 as described above and is further capable of executing application programs to serve various needs of the users of the system 10. The application programs are capable of performing one or several additional functions in the system 10, where each function can be independent of the others or can be integrated or coordinated together with functions performed by other applications. For example, the electronic device 16 can execute an application that manipulates images so the electronic device 16 can display the images on the illuminable assembly 14 or on the other display devices. In this manner, the electronic device 16 is capable of generating images that are capable of moving and interacting with a user, one of the physical objects, and each other.

Such images suitable for manipulation and display on the system 10 are known in the art as a sprite. A sprite is a graphic image that can move within a larger graphic. An application program such as an animation program that supports sprites allows for the development of independent animated images that can then be combined in a larger animation. Typically, each sprite has a set of rules that define how it moves and how it behaves if it bumps into another sprite or a static object.

Sprites can be derived from any combination of software developed and generated, live feeds or data streams such as those from the image capturing devices or derived from files in image or video formats such as GIF, JPEG, AVI, or other suitable formats. The sprites can be static or can change over time and can be animated or video.

Other applications the electronic device 16 is capable of executing include applications for the display of static or in motion textual information on the illuminable assembly 14 and on the other display devices to communicate with the user of the system 10. Still, other application programs the electronic device 16 is capable of executing include applications that replicate images across the illuminable assembly 14 and the other display devices so that users of the system 10 can look in more than one direction to obtain the same information or entertainment displayed on the various devices.

The system 10, in particular the electronic device 16, can execute application programs that manipulate sound and music data to produce or reproduce the sounds from the illuminable assembly 14 and the sound systems associated with the system 10. The sound and music data can be derived from any combination of software generated data, derived from sounds and music picked up by the microphones discussed above, live feeds or data streams, or derived from files in standard sound or music formats such as MIDI, MP3, WAV, or other like formats. As such, the ability of the electronic device 16 to execute various application programs allows the system 10 to display various visual effects on the illuminable assembly 14 and the other display devices to communicate with, interact with, teach, train, guide, or entertain the user.

The effects the system 10 is capable of displaying include visual explosions which can have a visual effect similar to an explosion of a firework or a starburst, mazes for the users to walk in, which may be scrollable by the user to advance the maze or to back up and try another pathway in the maze. Other visual effects displayable by the system 10 include simulated sports environments and the associated sporting components. For example, a baseball infield with bases and balls, hockey rinks with pucks, sticks and nets, simulated (i.e. sprites) or real players, boundary Lines or markers, goals or nets) sticks, clubs, bats, racquets, holes and hoops.

In a further aspect of the present invention, the system 10 is capable of executing software applications for use in teaching a user dance steps or can execute software applications that generate sound data based on dance steps performed by the user. In this manner, dance steps and sounds such as music can be coordinated and produced on the system 10. Other applications executable by the system 10 allow the system to provide the user with visual guidance cues that signal to the user physical places on the illuminable assembly 14 to approach, step on, avoid, chase, touch, kick, jump, or to take other actions. These visual guidance cues can also be used to signal to the user actions to be taken involving the physical object 12 or goods embedded with the physical object 12, speech or sounds uttered into the microphone or motions, positions, or patterns of action performed in front of one of the image capturing devices.

Hence, the ability of the system 10 to execute software applications allows the system to produce artistic or creative media that allows the user to create and manipulate sounds, images, or simulated objects on the illuminable assembly 14 and the other display devices through the use of one or more of the physical objects 12, the pressure sensor located in the illuminable assembly 14 or through other input devices of the system 10. Further examples of the ability of the system 10 to manipulate, generate, and produce patterns of light and images include the ability to coordinate the light patterns and images with speech, sounds, music and its beats and rhythms, produce various patterns and images corresponding to a frequency of the sound waves. In this manner, the system 10 is capable of computing or synchronizing coordinated data.

In another aspect of the present invention, the system 10 provides a significant educational tool for use in teaching or training one or more students. As an educational tool, the system 10 is capable of interacting with the students by visually displaying questions on the illuminable assembly 14 and the other display devices or by asking a student questions using the sound systems or the headphones. In response to the asked questions, the student can provide answers by their actions as observed, measured, or recorded by the system 10 using the illuminable assembly 14, data from one of the physical objects 12, images from the image capturing devices or utterances and sounds captured by the microphones. Moreover, the system 10, as an educational tool can provide the student with guidance cues as to what actions or action the student should take. For example, the electronic device 16 can illuminate the illuminable assembly 14 red to indicate a wrong selection or illuminate the illuminable assembly 14 green to indicate a correct selection and in conjunction with the visual guidance clues provide sound clues that encourage the student to try again if his or her selection was not correct or provides reinforcing sounds if the students selection is correct. The system 10 using the electronic device 16 is capable of providing other forms of feedback to the student or user so as to assist the student or user access his or her performance. Such other feedback includes sound and other sensory feedback such as vibrational forces.

Furthermore, the system 10 is capable of measuring and tabulating various statistics to indicate the accuracy, speed, precision, timing, locations, angles, swing, actions, or other performance measurements of the student. The system 10, as an educational tool, is well adapted to provide education and training in sporting activities such as perfection of ones golf swing, as well as providing educational activities and benefits in a more formal classroom environment found in elementary education, undergraduate education, graduate education, seminars and other educational venues.

The system 10 further includes an interface that allows software applications not originally designed for execution by the system 10 to execute on the system 10. As such, applications such as Doom and Quake are executable by the system 10 to allow a user of the system 10 to participate in a game of Doom or Quake. The interface of the system 10 is configurable to include a set of routines, functions, protocols, and tools for the application to interface with and use the various output devices of the system 10, i.e., the illuminable assembly 14. The system 10 can further be configured to execute an application that is capable of translating inputs of the user of the system 10 into appropriate inputs that the application program requires for operation.

In another aspect of the present invention, a first system 10A communicates with a second system 10B across a network. The first system 10A and the second system 10B are similar to the system 10 discussed above and each include one or more illuminable assemblies 14, one or more physical objects 12 and one or more electronic devices 16. Nevertheless, those skilled in the art will recognize that a third system 10C and a fourth system 10D, or more systems can also be coupled to the network so that several systems communicate from various physical locations using the network. Moreover, the physical location can be relatively close; for example, a different floor in the same building, or a different building on a campus, or the physical location can be located miles apart, in different towns, counties, states, countries or the like. In this manner, users of the system 10 are able to compete with local users and with users at a different physical location. That is a .user of the first system 10A can compete, cooperate, socialize, meet, communicate, play, work, train, exercise, teach, dance, or undertake another activity with a user of the second system 10B.

In this manner, the first system 10A and the second system 10B form a distributed system and can communicate with a central set of one or more servers over a network. The central set of servers coordinates the commands, controls, requests, and responses between the first system 10A and the second system 10B. This allows the users of the first system 10A to interact or communicate with the users of the second system 10B. Moreover, the central set of servers is able to provide the first system 10A and the second system 10B with one or more of the visual effects discussed above to further enhance user interaction and communication between the two systems.

In still another aspect of the present invention, the system 10 is able to communicate with an electronic device 16A. The electronic device 16A is capable of being a personal computer, a video game console such as Xbox™, PlayStation™, or other like video game console or other electronic device such as a PDA or mobile phone associated with a wireless network. In this manner, the user of the electronic device 16A is able to communicate with the system 10, for example, via a network, to interact and communicate with a user off the system 10. Moreover, the user of the electronic device 16A can submit requests to the system 10 for the performance of a selected visual effect or system function such as a status request or a system health request. Furthermore, the user of the electronic device 16A is able to compete with a user of the system 10 in entertainment and educational activities. As such, the ability of the system 10 to allow the user of the electronic device 16A to communicate with a user of the system 10 facilitates the use of the system 10 as an educational tool. For example, an instructor at one physical location can interact and communicate with multiple users of the system 10 across multiple systems, for example, the first system 10A and the second system 10B. In this manner, the instructor can monitor each student's performance and provide helpful feedback in the form of a visual message or an acoustic message to all students or a selected one of the students.

The set of servers is capable of providing the first system 10A and the second system 10B with additional functionality. For example, one of the servers in the set of servers can house a database of available software applications that can be selectively downloaded, either manually or automatically to either system according to business needs, user requests or contractual relationships. For example, the owner or operator of the first system 10A may subscribe to a basic set of software applications that allow him to access a first set of applications while the owner or operator of the second system 10B subscribes to an advanced package of software applications that allows him or her access to newer, more advanced or more popular, software application that are not included in the basic package provided to the operator of the first system 10A. Further, the set of servers is able to distribute and synchronize changes in each system 10. In this manner, each local copy of the software at each system 10 can be remotely updated in a distributed fashion. The changes to the local copies of the programs at each system 10 can occur in an automatic manner, for example, using a push technique or can occur in a manual manner, for example, waiting for the owner or operator of the system 10 to pull for an update. Those skilled in the art will recognize that each system 10 can be configured to automatically pull the set of servers for a program update at periodic intervals to further facilitate an automatic update of programs across various systems.

The set of servers can further support a database management system managing a database of specific user information. Such specific user information can include, but is not limited to, the user s name, age, contact information and billing information. The database can further hold information on each user concerning ownership information, such as what physical objects 12, licenses, programs, the end ˜user owns and when the physical objects 12 owned by the user contain information that allows the system 10 to identify the user by communicating with the physical object 12 for purposes such as billing user preferences, permissions, and other functions. As such, the physical object 12 owned by the user facilitates the updating of the database each time the user interacts with the system 10. As such, the system 10 can communicate with the physical object 12 to change the user's privileges or preferences based on the specific user data held by the database. For example, if the user purchases additional playtime, or purchases a higher level of rights, the system 10 can update the physical object 12 to reflect those changes allowing the user to travel to another system with his or her physical object 12 and automatically take advantage of his or her new level of benefits.

The database is capable of holding user preferences for various software applications or other programs, for example, applications that was not originally designed and written for use on the system 10, such as Doom. Furthermore, the system 10 is capable of using the database to tabulate statistics for one or more of the users. As such, scores, results, usage patterns, or other assessment measures can be held by the database and accessed by the user using his or her physical object 12 or using a personal electronic device, such as a mobile phone or personal computer. The user can also take advantage of the databases ability to hold information regarding a users goals, desires, intentions or other information that allow the various software applications executed by the electronic device 16 to customize or personalize interactions between the user and the system 10 or between other users. For example, the user can set a goal or desire to perform twenty-five practice swings or shots before beginning or entering a game or activity.

Moreover, the user is able to submit database queries using a graphical user interface. The graphical user interface can be web-based and executable by a browser on the user's personal computer. In this manner, the user can change portions of the information, such as their current contractual relationship, their preferences, or communicate with other users to reserve a time on the system and schedule a desired activity for that scheduled time period. Furthermore, the user can use the graphical user interface to interact with or coordinate with other users who are using another browser or who are using the system 10.

The set of servers is further capable of providing functions that allow the user of the system 10 or another entity to submit applications created for execution on the system 10. The submission of the application to the set or services is accomplished by e-mail, a web transaction or other like method. In like fashion, the user of the system 10 or the creator of an application for execution on the system 10 can access the set of servers to add, modify, or delete an application held by the server or by a database accessible by the set or servers. Furthermore, the set of servers are capable of monitoring usage of applications on each system 10, and, in turn, calculate payments of royalties or other forms of compensation based on usage or calculate and make payment of royalties or other forms of compensation based on other contractual parameters such as the submission, the licensing or transfer of ownership rights in an application executable by the system 10.

In one aspect of the present invention, a software development kit (SDK) is provided that allows selected users or other individuals to create software applications for execution by the system 10. The SDK provides tools, frame-works, software hooks, functions, and other software components that are helpful or necessary for the software application to work with the system 10. In this manner, an individual or an entity is able to create and develop a software application for use with the system 10 to provide further educational, gaming, sporting, and entertainment opportunities to the users of the system 10.

While this invention has been described in terms of a best mode for achieving the objectives of the invention, it will be appreciated by those skilled in the wireless communications art that variations may be accomplished in view of these teachings without deviating from the spirit or scope of the present invention. For example, the present invention may be implemented using any combination of computer programming software, firmware or hardware. As a preparatory step to practicing the invention or constructing an apparatus according to the invention, the computer programming code (whether software or firmware) according to the invention will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the computer programming code is used by either executing the code directly from the storage device, by copying the code from the storage device into another storage device such as a hard disk, RAM, etc., or by transmitting the code on a network for remote execution.

What is claimed is:

1. A user interactive system component, the component comprising:
means for detecting some physical characteristic of a user proximal to the user interactive system component; and
means for transmitting the detected physical characteristic in a data signal to a user interactive system controller.

2. The user interactive system component of claim 1, further comprising means for generating a user detectable effect as a function of the detected physical characteristic.

3. The user interactive system component of claim 1, further comprising:
means for receiving a generate effect data signal from the user interactive system controller where the generate effect data signal is based on the detected physical characteristic; and
means for generating a user detectable effect based on the generate effect data signal.

4. The user interactive system component of claim 2, wherein the means for generating a user detectable effect based on the generate effect data signal includes an illumination element.

5. The user interactive system component of claim 3, wherein the means for generating a user detectable effect based on the generate effect data signal includes an illumination element.

6. The user interactive system component of claim 2, wherein the means for detecting some physical characteristic of a user proximal to the user interactive system component includes a user tracking component, the user tracking component including means for detecting some physical characteristic of the user and means for transmitting the detected physical characteristic to the user interactive system component.

7. The user interactive system component of claim 3, wherein the means for detecting some physical characteristic of a user proximal to the user interactive system component includes a user tracking component, the user tracking component including means for detecting some physical characteristic of the user and means for transmitting the detected physical characteristic to the user interactive system component.

8. The user interactive system component of claim 6, further comprising means for communicating with another user interactive system component.

9. The user interactive system component of claim 7, further comprising means for communicating with another user interactive system component.

10. The user interactive system component of claim 6, further comprising means for physically supporting the user.

11. The user interactive system component of claim 7, further comprising means for physically supporting the user.

12. A user interactive system, the system comprising:
a user interactive system controller operable to enable data communications; and
a user interactive system component operable to enable data communications with the user interactive system controller, the component including means for detecting some physical characteristic of a user proximal to the user interactive system component and transmitting the detected physical characteristic in a data signal to the user interactive system controller.

13. The user interactive system of claim 12, the system component further comprising means for generating a user detectable effect as a function of the detected physical characteristic.

14. The user interactive system of claim 12, the controller including means for generating an effect data signal based on the detected physical characteristic data signal and the system component further comprising:
means for receiving the generate effect data signal from the user interactive system controller; and
means for generating a user detectable effect based on the generate effect data signal.

15. The user interactive system of claim 13, wherein the means for generating a user detectable effect based on the generate effect data signal includes an illumination element.

16. The user interactive system of claim 14, wherein the means for generating a user detectable effect based on the generate effect data signal includes an illumination element.

17. The user interactive system of claim 13, wherein the means for detecting some physical characteristic of a user proximal to the user interactive system component includes a user tracking component, the user tracking component including means for detecting some physical characteristic of the user and means for transmitting the detected physical characteristic to the user interactive system component.

18. The user interactive system of claim 14, wherein the means for detecting some physical characteristic of a user proximal to the user interactive system component includes a user tracking component, the user tracking component including means for detecting some physical characteristic of the user and means for transmitting the detected physical characteristic to the user interactive system component.

19. The user interactive system of claim 17, wherein the system component further includes means for communicating with another user interactive system component.

20. The user interactive system of claim 18, wherein the system component further includes means for communicating with another user interactive system component.

21. The user interactive system of claim 17, wherein the system component further includes means for physically supporting the user.

22. The user interactive system of claim 18, wherein the system component further includes means for physically supporting the user.

23. A method for a user interactive system component, the method comprising the steps of:
detecting some physical characteristic of a user proximal to the user interactive system component; and
transmitting the detected physical characteristic in a data signal to a user interactive system controller.

24. The method for a user interactive system component of claim 23, further comprising the step of generating a user detectable effect as a function of the detected physical characteristic.

25. The method for a user interactive system component of claim 23, further comprising the steps of:
receiving a generate effect data signal from the user interactive system controller where the generate effect data signal is based on the detected physical characteristic; and
generating a user detectable effect based on the generate effect data signal.

26. The method for a user interactive system component of claim 24, wherein the step of generating a user detectable effect based on the generate effect data signal includes illuminating an element.

27. The method for a user interactive system component of claim 25, wherein the step of generating a user detectable effect based on the generate effect data signal includes illuminating an element.

28. The method for a user interactive system component of claim 24, wherein the step of detecting some physical characteristic of a user proximal to the user interactive system component includes the step of employing a user tracking component to detect some physical characteristic of the user and transmit the detected physical characteristic to the user interactive system component.

29. The method for a user interactive system component of claim 25, wherein the step of detecting some physical characteristic of a user proximal to the user interactive system component includes the step of employing a user tracking component to detect some physical characteristic of the user and transmit the detected physical characteristic to the user interactive system component.

30. The method for a user interactive system component of claim 28, further comprising the step of communicating with another user interactive system component.

31. The method for a user interactive system component of claim 29, further comprising the step of communicating with another user interactive system component.

32. An article of manufacture for use in operating a user interactive system component, the article of manufacture comprising computer readable storage media including program logic embedded therein that causes control circuitry to perform the steps of:
detecting some physical characteristic of a user proximal to the user interactive system component; and
transmitting the detected physical characteristic in a data signal to a user interactive system controller.

33. The article of manufacture of claim 32, further causing the control circuitry to perform the step of generating a user detectable effect as a function of the detected physical characteristic.

34. The article of manufacture of claim 32, further causing the control circuitry to perform the steps of:
receiving a generate effect data signal from the user interactive system controller where the generate effect data signal is based on the detected physical characteristic; and
generating a user detectable effect based on the generate effect data signal.

35. The article of manufacture of claim 33, wherein the step of generating a user detectable effect based on the generate effect data signal includes illuminating an element.

36. The article of manufacture of claim 34, wherein the step of generating a user detectable effect based on the generate effect data signal includes illuminating an element.

37. The article of manufacture of claim 33, wherein the step of detecting some physical characteristic of a user proximal to the user interactive system component includes the step of employing a user tracking component to detect some physical characteristic of the user and transmit the detected physical characteristic to the user interactive system component.

38. The article of manufacture of claim 34, wherein the step of detecting some physical characteristic of a user proximal to the user interactive system component includes the step of employing a user tracking component to detect some physical characteristic of the user and transmit the detected physical characteristic to the user interactive system component.

39. The article of manufacture of claim 37, further causing the control circuitry to perform the step of communicating with another user interactive system component.

40. The article of manufacture of claim 38, further causing the control circuitry to perform the step of communicating with another user interactive system component.
